(19) United States
(12) Patent Application Publication
(10) Pub. No.: US 2011/0134772 A1
(43) Pub. Date: Jun. 9, 2011

(54) Methods of radio communication involving multiple radio channels, and radio signal repeater and mobile station apparatuses implementing same

(75) Inventors: Hang Zhang, Nepean (CA); Wen Tong, Ottawa (CA); Jianglei Ma, Kanata (CA); Peiying Zhu, Kanata (CA); Ming Jia, Ottawa (CA)

(73) Assignee: Nortel Networks Limited

(21) Appl. No.: 12/923,519

(22) Filed: Sep. 24, 2010

Related U.S. Application Data
(60) Provisional application No. 12/806,210, filed on Sep. 24, 2009.

(51) Int. Cl. H04W 40/00; H04J 4/00; H04W 24/00

(52) U.S. Cl. 370/252; 370/315

(57) ABSTRACT

A method of facilitating radio communications involves receiving a first message from a first remote radio station on a first radio channel, transmitting the first message to a second remote radio station on a second radio channel, receiving a second message from the second remote radio station on a third radio channel, and transmitting the second message to the first remote radio station on a fourth radio channel. A method of radio communication involves receiving a first radio signal from a first remote radio station on a first radio channel, transmitting a second radio signal to the first remote radio station on a second radio channel, receiving a third radio signal from a second remote radio station on a third radio channel, and transmitting a fourth radio signal to the second remote radio station on a fourth radio channel. Radio signal repeater and mobile station apparatuses are also disclosed.

### CROSS-REFERENCE TO RELATED APPLICATION

This application claims the benefit of U.S. provisional patent application No. 61/245,349 filed Sep. 24, 2009, which is incorporated by reference herein in its entirety.

This application is a continuation-in-part of a non-provisional application (serial number to be determined) resulting from a conversion under 37 C.F.R. §1.53(c)(3) of U.S. provisional patent application No. 61/245,349 filed Sep. 24, 2009, which claims the benefit of U.S. provisional patent application No. 61/100,906 filed Sep. 29, 2008, and which is incorporated by reference herein in its entirety.

### BACKGROUND

1. Field of Invention

The invention relates generally to radio communication, and more particularly to methods of radio communication involving multiple radio channels and to apparatuses implementing the same.

2. Description of Related Art

Numerous standards for radio communication are known. For example, the Global System for Mobile Communications (“GSM”) standard is a radio communication standard for mobile telephones, and prescribes radio frequencies ranging from about 380 MHz to about 2 GHz. Other radio communication standards for mobile telephones include the Time Division Multiple Access (“TDMA”) standard and the Code Division Multiple Access (“CDMA”) standard, and these standards also generally prescribe radio frequencies less than about 2.5 GHz. The Institute of Electrical and Electronics Engineers (“IEEE”) 802.11 and 802.16 standards are other radio communication standards that prescribe radio signals having frequencies less than about 5 GHz.

These standards generally prescribe radio signals at relatively low radio frequencies, and generally lower radio frequencies permit lower operating bandwidth than higher radio frequencies. However, higher radio frequencies generally have shorter range and generally are more sensitive to environmental interference (such as rain and oxygen absorption, for example) than lower radio frequencies. Such shorter range may require radio frequency repeaters that are closer together, but positioning known repeaters closer together may cause disadvantageously cause interference between the signals of the repeaters. Therefore, many known standards for radio communication prescribe radio signals at relatively low radio frequencies to avoid such disadvantages of higher radio frequencies and to use commercially wireless hardware, but disadvantageously provide lower bandwidths because of the relatively low radio frequencies, and are disadvantageously limited to available radio frequency bands at such relatively low radio frequencies.

### SUMMARY

In accordance with one illustrative embodiment, there is provided a method of facilitating radio communications. The method involves: receiving, at a radio signal repeater from a first remote radio station on a first radio channel, a first radio signal encoded with a first message; after receiving the first radio signal, transmitting, from the radio signal repeater to a second remote radio station on a second radio channel different from the first radio channel, a second radio signal encoded with the first message; receiving, at the radio signal repeater from the second remote radio station on a third radio channel different from the first and second radio channels, a third radio signal encoded with a second message; and after receiving the third radio signal, transmitting, from the radio signal repeater to the first remote radio station on a fourth radio channel different from the first, second, and third radio channels, a fourth radio signal encoded with the second message.

The first, second, third, and fourth radio channels may be frequency-division multiplexed on first, second, third, and fourth different radio frequency bands respectively.

The first and fourth radio channels may time-division multiplexed on a first radio frequency band, and the second and third radio channels may be time-division multiplexed on a second radio frequency band different from the first radio frequency band.

The method may further involve receiving, at the radio signal repeater, configuration information encoded in a configuration information signal in a configuration radio frequency band different from respective radio frequency bands of the first, second, third, and fourth radio channels.

The configuration radio frequency band may be between about 57 GHz and about 64 GHz.

The first, second, third, and fourth radio channels may have respective radio frequencies between about 57 GHz and about 64 GHz.

Transmitting the second radio signal may involve amplifying the first radio signal, and transmitting the fourth radio signal may involve amplifying the third radio signal.

Transmitting the second radio signal may involve digitally decoding the first message from the first radio signal and encoding the decoded first message for the second radio signal, and transmitting the fourth radio signal may involve digitally decoding the second message from the third radio signal and encoding the decoded second message for the fourth radio signal.

The method may further involve determining a first signal-to-noise ratio representing a ratio of strength of the first radio signal to noise in the first radio signal at the radio signal repeater, and determining a second signal-to-noise ratio representing a ratio of strength of the third radio signal to noise in the third radio signal at the radio signal repeater. If the first signal-to-noise ratio satisfies a first criterion, transmitting the second radio signal may involve amplifying the first radio signal. If the first signal-to-noise ratio does not satisfy the first criterion, transmitting the second radio signal may involve digitally decoding the first message from the first radio signal and encoding the decoded first message for the second radio signal. If the second signal-to-noise ratio satisfies a second criterion, transmitting the fourth radio signal may involve amplifying the third radio signal. If the second signal-to-noise ratio does not satisfy the second criterion, transmitting the fourth radio signal may involve digitally decoding the second message from the third radio signal and encoding the decoded second message for the fourth radio signal.

The first signal-to-noise ratio may satisfy the first criterion if the first signal-to-noise ratio exceeds a first threshold, and the first signal-to-noise ratio may not satisfy the first criterion if the first signal-to-noise ratio does not exceed the first threshold. The second signal-to-noise ratio may satisfy the second criterion if the second signal-to-noise ratio exceeds a second threshold, and the second signal-to-noise ratio may not satisfy the second criterion if the second signal-to-noise ratio does not exceed the second threshold.

The method may further involve: before transmitting the second radio signal, receiving, at the radio signal repeater from the first remote radio station on the second radio channel, a fifth radio signal encoded with the first message, the first radio signal being stronger than the fifth radio signal; and comparing respective signal strengths of the first and fifth radio signals to determine that the first radio signal is stronger than the fifth radio signal. Transmitting the second radio signal may involve selecting the second radio channel instead of the first radio channel for the second radio signal in response to determining that the first radio signal is stronger than the fifth radio signal.

The method may further involve: receiving, at the radio signal repeater from the first remote radio station on the first radio channel, a sixth radio signal encoded with a third message; after receiving the sixth radio signal, transmitting, to a third remote radio station on a fifth radio channel different from the first, second, third, and fourth radio channels, a seventh radio signal encoded with the third message; receiving, at the radio signal repeater from the third remote radio station on the fifth radio channel, an eighth radio signal encoded with a fourth message; and after receiving the eighth radio signal, transmitting, to the first remote radio station on the fourth radio channel, a ninth radio signal encoded with the fourth message.

The fifth radio channel may have a radio frequency less than about 5 GHz.

Receiving the sixth radio signal may involve receiving the sixth radio signal on a subchannel of the first radio channel associated with the third remote radio station. Transmitting the seventh radio signal may involve transmitting the seventh radio signal on a subchannel of the fifth radio channel associated with the third remote radio station. Receiving the eighth radio signal may involve receiving the eighth radio signal on the subchannel of the fifth radio channel associated with the third remote radio station. Transmitting the ninth radio signal may involve transmitting the ninth radio signal on a subchannel of the fourth radio channel associated with the third remote radio station.

The sixth radio signal may include a destination field including destination data designating the third remote radio station.

The method may further involve: receiving the second radio signal at the second remote radio station from the radio signal repeater; and after receiving the second radio signal, transmitting, from the second remote radio station to a fourth remote radio station on the first radio channel, a tenth radio signal encoded with the first message.

The method may further involve, before transmitting the third radio signal, receiving, at the second remote station from the fourth remote station on the fourth radio channel, an eleventh radio signal encoded with the second message.

In accordance with another illustrative embodiment, there is provided a radio signal repeater apparatus including: provisions for receiving, from a first remote radio station on a first radio channel, a first radio signal encoded with a first message; provisions for transmitting, after receiving the first radio signal, a second radio signal to a second remote radio station on a second radio channel different from the first radio channel, the second radio signal encoded with the first message; provisions for receiving, from the second remote radio station on a third radio channel different from the first and second radio channels, a third radio signal encoded with a second message; and provisions for transmitting, after receiving the third radio signal, a fourth radio signal to the first remote radio station on a fourth radio channel different from the first, second, and third radio channels, the fourth radio signal encoded with the second message.

In accordance with another illustrative embodiment, there is provided a radio signal repeater apparatus including: an interface for facilitating radio communication with first and second remote radio stations on first, second, third, and fourth different radio channels; and a processor in communication with the interface. The processor is operably configured to: receive, from the interface, a first radio signal from the first remote radio station on the first radio channel, the first radio signal encoded with a first message; cause the interface to transmit, after receiving the first radio signal, a second radio signal to the second remote radio station on the second radio channel, the second radio signal encoded with the first message; receive, from the interface, a third radio signal from the second remote radio station on the third radio channel, the third radio signal encoded with a second message; and cause the interface to transmit, after receiving the third radio signal, a fourth radio signal to the first remote radio station on the fourth radio channel, the fourth radio signal encoded with the second message.

The first, second, third, and fourth radio channels may be frequency-division multiplexed on first, second, third, and fourth different radio frequency bands respectively.

The first and fourth radio channels may be time-division multiplexed on a first radio frequency band, and the second and third radio channels may be time-division multiplexed on a second radio frequency band different from the first radio frequency band.

The processor may be further operably configured to receive, from the interface, configuration information encoded in a configuration information signal in a configuration radio frequency band different from respective radio frequency bands of the first, second, third, and fourth radio channels.

The configuration radio frequency band may be between about 57 GHz and about 64 GHz.

The first, second, third, and fourth radio channels may have respective radio frequencies between about 57 GHz and about 64 GHz.

The processor may be operably configured to cause the interface to transmit the second radio signal by amplifying the first radio signal, and the processor may be operably configured to cause the interface to transmit the fourth radio signal by amplifying the third radio signal.

The processor may be operably configured to cause the interface to transmit the second radio signal by digitally decoding the first message from the first radio signal and by encoding the decoded first message for the second radio signal, and the processor may be operably configured to cause the interface to transmit the fourth radio signal by digitally decoding the second message from the third radio signal and by encoding the decoded second message for the fourth radio signal.

The processor may be further operably configured to determine a first signal-to-noise ratio representing a ratio of strength of the first radio signal to noise in the first radio signal at the interface. The processor may be operably configured to cause the interface to transmit the second radio signal by amplifying the first radio signal if the first signal-to-noise ratio satisfies a first criterion. The processor may be operably configured to cause the interface to transmit the second radio signal by digitally decoding the first message from the first radio signal and by encoding the decoded first message for the second radio signal if the first signal-to-noise ratio does not satisfy the first criterion. The processor may be further operably configured to determine a second signal-to-noise ratio representing a ratio of strength of the third radio signal to noise in the third radio signal at the interface. The processor may be operably configured to cause the interface to transmit the fourth radio signal by amplifying the third radio signal if the second signal-to-noise ratio satisfies a second criterion. The processor may be operably configured to cause the interface to transmit the fourth radio signal by digitally decoding the second message from the third radio signal and by encoding the decoded second message for the fourth radio signal if the second signal-to-noise ratio does not satisfy the second criterion.

The first signal-to-noise ratio may satisfy the first criterion if the first signal-to-noise ratio exceeds a first threshold, and the first signal-to-noise ratio may not satisfy the first criterion if the first signal-to-noise ratio does not exceed the first threshold. The second signal-to-noise ratio may satisfy the second criterion if the second signal-to-noise ratio exceeds a second threshold, and the second signal-to-noise ratio may not satisfy the second criterion if the second signal-to-noise ratio does not exceed the second threshold.

The processor may be further operably configured to: receive from the interface, before transmitting the second radio signal, a fifth radio signal from the first remote radio station on the second radio channel, the fifth radio signal encoded with the first message and not as strong as the first radio signal; compare respective signal strengths of the first and fifth radio signals; and select the second radio channel instead of the first radio channel for the second radio signal if the first radio signal is stronger than the fifth radio signal.

The processor may be further operably configured to: receive, from the interface, a sixth radio signal from the first remote radio station on the first radio channel, the sixth radio signal encoded with a third message; after receiving the sixth radio signal, cause the interface to transmit, to a third remote radio station on a fifth radio channel different from the first, second, third, and fourth radio channels, a seventh radio signal encoded with the third message; receive, from the interface, an eighth radio signal from the third remote radio station on the fifth radio channel, the eighth radio signal encoded with a fourth message; and after receiving the eighth radio signal, cause the interface to transmit, to the first remote radio station on the fourth radio channel, a ninth radio signal encoded with the fourth message.

The fifth radio channel may have a radio frequency less than about 5 GHz.

The processor may be operably configured to receive the sixth radio signal on a subchannel of the first radio channel associated with the third remote radio station. The processor may be operably configured to transmit the seventh radio signal on a subchannel of the fifth radio channel associated with the third remote radio station. The processor may be operably configured to receive the eighth radio signal on the subchannel of the fifth radio channel associated with the third remote radio station. The processor may be operably configured to transmit the ninth radio signal on a subchannel of the fourth radio channel associated with the third remote radio station.

The sixth radio signal may include a destination field including destination data, and the processor may be operably configured to cause the interface to transmit the seventh radio signal in response to receiving the sixth radio signal when the destination field of the sixth radio signal includes destination data designating the third remote radio station.

In accordance with another illustrative embodiment, there is provided a method of radio communication. The method involves: receiving a first radio signal at a mobile station from a first remote radio station on a first radio channel; transmitting a second radio signal from the mobile station to the first remote radio station on a second radio channel associated with the first radio channel and different from the first radio channel; receiving a third radio signal at the mobile station from a second remote radio station on a third radio channel different from the first and second radio channels; and transmitting a fourth radio signal from the mobile station to the second remote radio station on a fourth radio channel associated with the third radio channel and different from the first, second, and third radio channels.

The first, second, third, and fourth radio channels may be frequency-division multiplexed on first, second, third, and fourth different radio frequency bands respectively.

The first and second radio channels may be time-division multiplexed on a first radio frequency band, and the third and fourth radio channels may be time-division multiplexed on a second radio frequency band different from the first radio frequency band.

The method may further involve receiving, at the mobile station, configuration information encoded in a configuration information signal in a configuration radio frequency band different from respective radio frequency bands of the first, second, third, and fourth radio channels.

The configuration radio frequency band may be between about 57 GHz and about 64 GHz.

The first, second, third, and fourth radio channels may have respective radio frequencies between about 57 GHz and about 64 GHz.

In accordance with another illustrative embodiment, there is provided a mobile station apparatus including: provisions for receiving a first radio signal from a first remote radio station on a first radio channel; provisions for transmitting a second radio signal to the first remote radio station on a second radio channel associated with the first radio channel and different from the first radio channel; provisions for receiving a third radio signal from a second remote radio station on a third radio channel different from the first and second radio channels; and provisions for transmitting a fourth radio signal to the second remote radio station on a fourth radio channel associated with the third radio channel and different from the first, second, and third radio channels.

In accordance with another illustrative embodiment, there is provided a mobile station apparatus including: an interface for facilitating radio communication with first and second remote radio stations on first, second, third, and fourth different radio channels; and a processor in communication with the interface. The processor is operably configured to: receive, from the interface, a first radio signal from a first remote radio station on a first radio channel; cause the interface to transmit a second radio signal to the first remote radio station on a second radio channel associated with the first radio channel and different from the first radio channel; receive, from the interface, a third radio signal from a second remote radio station on a third radio channel different from the first and second radio channels; and cause the interface to transmit a fourth radio signal to the second remote radio station on a fourth radio channel associated with the third radio channel and different from the first, second, and third radio channels.

The first, second, third, and fourth radio channels may be frequency-division multiplexed on first, second, third, and fourth different radio frequency bands respectively.

The first and second radio channels may be time-division multiplexed on a first radio frequency band, and the third and fourth radio channels may be time-division multiplexed on a second radio frequency band different from the first radio frequency band.

The processor may be further operably configured to receive, from the interface, configuration information encoded in a configuration information signal in a configuration radio frequency band different from respective radio frequency bands of the first, second, third, and fourth radio channels.

The configuration radio frequency band may be between about 57 GHz and about 64 GHz.

The first, second, third, and fourth radio channels may have respective radio frequencies between about 57 GHz and about 64 GHz.

Other aspects and features will become apparent to those ordinarily skilled in the art upon review of the following description of illustrative embodiments in conjunction with the accompanying figures.

### BRIEF DESCRIPTION OF THE DRAWINGS

In drawings of various illustrative embodiments:

FIG. 1 is a top-view schematic representation of an illustrative radio communication system;

FIG. 2 is a schematic representation of a base station of the radio communication system of FIG. 1;

FIG. 3 is a schematic representation of downlink codes of the base station of FIG. 2;

FIG. 4 is a schematic representation of a downlink signal transmitted by a radio communication interface of the base station of FIG. 2;

FIG. 5 is a schematic representation of uplink codes of the base station of FIG. 2;

FIG. 6 is a schematic representation of an uplink signal received at the radio communication interface of the base station of FIG. 2;

FIG. 7 is a schematic representation of configuration codes of the base station of FIG. 2;

FIG. 8 is a schematic representation of a configuration signal transmitted by the radio communication interface of the base station of FIG. 2;

FIG. 9 is a schematic representation of a radio signal repeater of the radio communication system of FIG. 1;

FIG. 10 is a schematic representation of downlink codes of the radio signal repeater of FIG. 9;

FIG. 11 is a schematic representation of uplink codes of the radio signal repeater of FIG. 9;

FIG. 12 is a schematic representation of configuration codes of the radio signal repeater of FIG. 9;

FIG. 13 is a schematic representation of a mobile station of the radio communication system of FIG. 1;

FIG. 14 is a schematic representation of downlink codes of the mobile station of FIG. 13;

FIG. 15 is a schematic representation of uplink codes of the mobile station of FIG. 13;

FIG. 16 is a schematic representation of configuration codes of the mobile station of FIG. 13;

FIG. 17 is a schematic representation of illustrative signals transmitted and received in the radio communication system of FIG. 1;

FIG. 18 is a schematic representation of other illustrative signals transmitted and received in the radio communication system of FIG. 1;

FIG. 19 is a schematic representation of other illustrative signals transmitted and received in the radio communication system of FIG. 1; and

FIG. 20 is a schematic representation of other illustrative signals transmitted and received in the radio communication system of FIG. 1.

### DETAILED DESCRIPTION

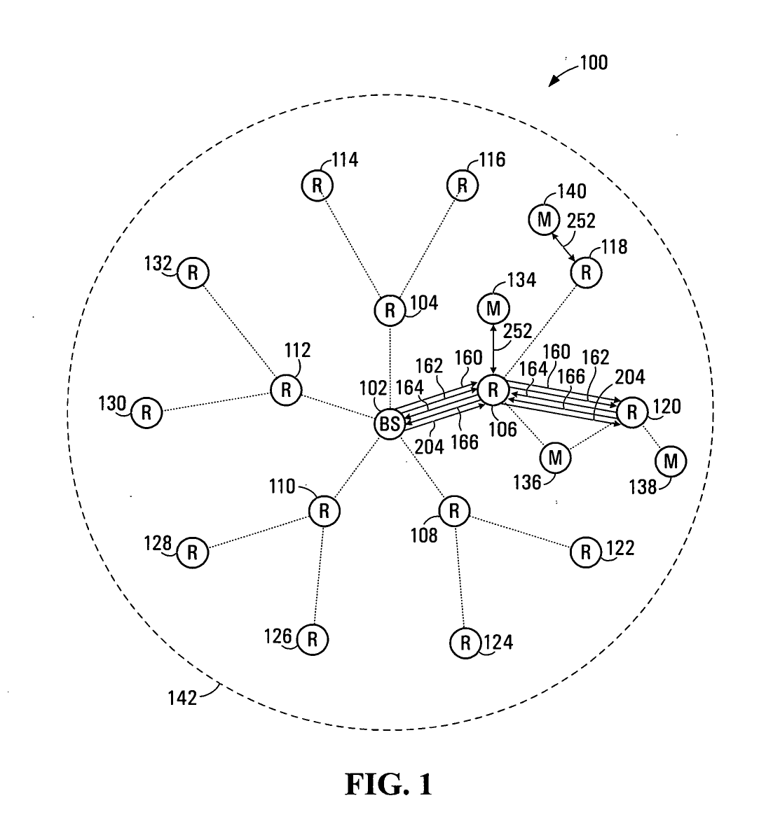

Referring to FIG. 1, an exemplary radio communication system is shown generally at 100 and includes a base station 102, radio signal repeaters 104, 106, 108, 110, 112, 114, 116, 118, 120, 122, 124, 126, 128, 130, and 132, and mobile stations 134, 136, 138, and 140. In the embodiment shown, the mobile station 134 is in radio communication with the radio signal repeater 106, the mobile station 136 is in radio communication with the radio signal repeaters 106 and 120, and the mobile station 140 is in radio communication with the radio signal repeater 118. Generally, the base station 102 and the radio signal repeaters 104, 106, 108, 110, 112, 114, 116, 118, 120, 122, 124, 126, 128, 130, and 132 have respective radio communication ranges that overlap and collectively communicate by radio with mobile stations such as the mobile stations 134, 136, 138, and 140 in a coverage area 142 surrounding the base station 102. The base station 102, the radio signal repeaters 104, 106, 108, 110, 112, 114, 116, 118, 120, 122, 124, 126, 128, 130, and 132, and the mobile stations 134, 136, 138, and 140 may be referred to simply as radio stations.

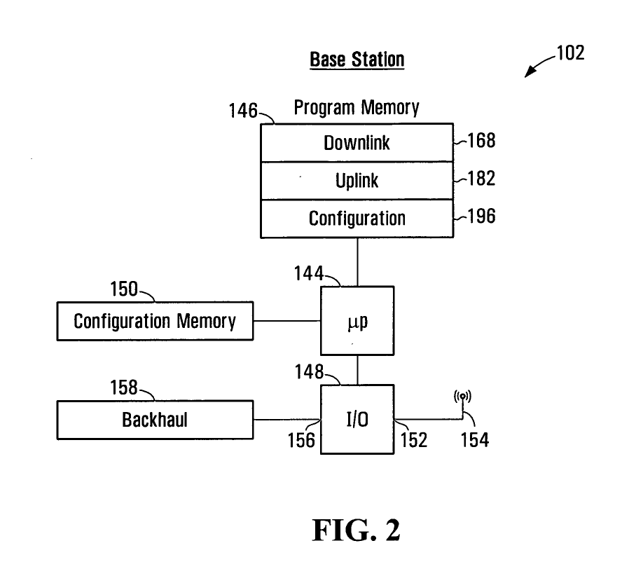

Referring to FIG. 2, the base station 102 (also shown in FIG. 1) is illustrated schematically, and in the embodiment shown includes a microprocessor 144 and program memory 146, an input/output (“I/O”) module 148, and configuration memory 150. The program memory 146 in the embodiment shown includes random-access memory (“RAM”) encoded with codes generally for directing the microprocessor 144 to carry out functions of the base station 102. The I/O module 148 includes a radio communication port 152 in communication with a radio antenna 154. The I/O module 148 also includes a backhaul port 156 for communicating with a backhaul 158 of the base station 102. The backhaul 158 connects the base station 102 to other base stations in a radio communication network and to other communication networks, such as telephone networks and the internet for example, to facilitate communication between mobile stations in the coverage area 142 (shown in FIG. 1) with mobile stations (not shown) outside of the coverage area (142) and with other telephones and computers on the internet (not shown), for example. The configuration memory 150 in the embodiment shown is also a RAM, and generally stores data for configuring the base station 102. Although the base station 102 in the embodiment shown includes the microprocessor 144, the program memory 146, the I/O module 148, and the configuration memory 150, alternative base stations may include additional or alternative components such as hard drives and application-specific integrated circuits (“ASICs”), for example.

Referring to FIGS. 1 and 2, the radio antenna 154 in the embodiment shown facilitates radio communication with the radio signal repeaters 104, 106, 108, 110, and 112 on at least five different radio channels, namely first and second downlink radio channels 160 and 162, first and second uplink radio channels 164 and 166, and a configuration and control radio channel 204. Although for simplicity the radio channels 160, 162, 164, 166, and 204 are illustrated in FIG. 1 only between the base station 102 and the radio signal repeater 106 and between the radio signal repeaters 106 and 120, in the embodiment shown the base station 102 is also in radio communication with the radio signal repeaters 106, 108, 110, and 112, the radio signal repeater 104 is in radio communication with the radio signal repeaters 114 and 116, the radio signal repeater 106 is in radio communication with the radio signal repeaters 118 and 120, the radio signal repeater 108 is in radio communication with the radio signal repeaters 122 and 124, the radio signal repeater 110 is in radio communication with the radio signal repeaters 126 and 128, and the radio signal repeater 112 is in radio communication with the radio signal repeaters 130 and 132, all on the radio channels 160, 162, 164, 166, and 204. The radio antenna 154 thus functions as a radio communication interface, or simply as an interface, to the radio signal repeaters 104, 106, 108, 110, and 112 in the embodiment shown.

Herein, “radio channel” refers to a multiplexed communication channel in one or more radio or other electromagnetic frequency bands. In the embodiment shown, the base station 102 is configurable to multiplex the radio channels 160, 162, 164, and 166 using frequency-division multiplexing, in which case the radio channels 160, 162, 164, and 166 are multiplexed onto respective different radio frequency bands. The base station 102 in the embodiment shown is also configurable to multiplex the radio channels 160, 162, 164, and 166 using time-division multiplexing, in which case the first downlink radio channel 160 and the first uplink radio channel 164 are time-division multiplexed in a first radio frequency band, and the second downlink radio channel 162 and the second uplink radio channel 166 are time-division multiplexed in a second radio frequency band different from the first radio frequency band. However, in any case in the embodiment shown, the configuration and control radio channel 204 is multiplexed in a frequency band different from frequency bands of the radio channels 160, 162, 164, and 166. Alternative base stations may multiplex the radio channels 160, 162, 164, 166, and 204 using different multiplexing techniques, and the configuration memory 150 in the embodiment shown stores configuration data specifying a particular multiplexing technique for the base station 102.

In the embodiment shown, the radio channels 160, 162, 164, 166, and 204 are in respective radio frequency bands in a radio frequency band between about 57 GHz and about 64 GHz, which may be referred to for simplicity as the “60 GHz” band and which is unlicensed in the United States. In alternative embodiments, the radio channels 160, 162, 164, 166, and 204 may have other radio frequencies, such as other radio frequencies known as Extremely High Frequencies (“EHF”) between about 30 GHz and 300 GHz, for example. The respective radio frequency bands of the radio channels 160, 162, 164, 166, and 204 are also specified in the configuration memory 150 in the embodiment shown.

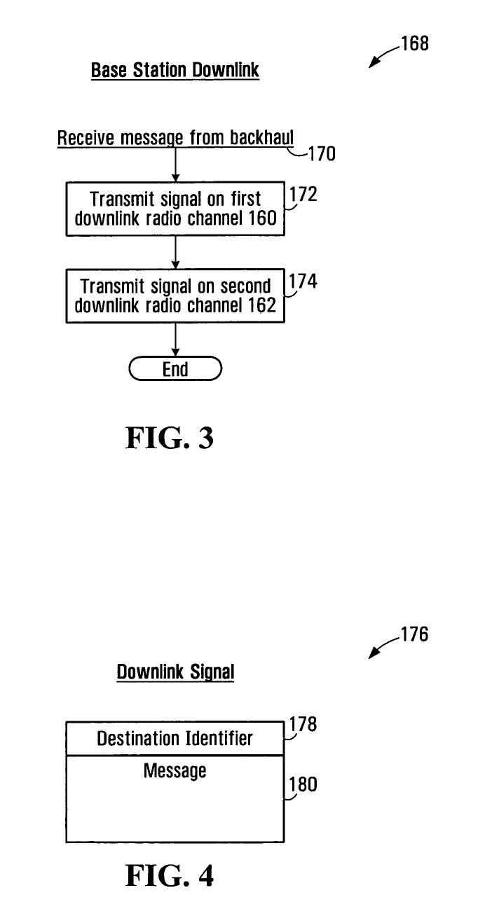

Referring back to FIG. 2, the program memory 146 includes downlink codes 168 that include blocks of code for directing the microprocessor 144 to transmit a downlink signal. Referring to FIG. 3, the downlink codes 168 are illustrated schematically and begin at 170 in response to receiving a downlink message from the backhaul 158 (shown in FIG. 2). A downlink message received at 170 from the backhaul (158) may include any message directed to a mobile station in the coverage area 142 (such as the mobile stations 134, 136, 138 and 140 shown in FIG. 1), and may include a voice message, a data message, or a configuration message, for example. The downlink codes 168 continue at block 172, which directs the microprocessor (144) to cause the radio antenna 154 to transmit a downlink signal encoded with the downlink message received at 170 on the first downlink radio channel 160. The downlink codes 168 continue at block 174, which directs the microprocessor (144) to transmit a downlink signal encoded with the downlink message received at 170 on the second downlink radio channel 162. The downlink codes 168 then end.

Therefore, in the embodiment shown, the base station (102) receives a downlink message from the backhaul (158), and the base station (102) transmits downlink signals including that message on both the first and second downlink radio channels 160 and 162. Alternative base stations may transmit a signal on only one of the first and second downlink radio channels 160 and 162, in which case one of the blocks 172 and 174 may be omitted. Still other alternative base stations may select one of the first and second downlink radio channels 160 and 162 for downlink signals directed to particular radio signal repeaters in radio communication with the base station.

Referring to FIG. 4, an exemplary downlink signal transmitted in response to the codes in block 172 or 174 (shown in FIG. 3) is shown generally at 176, and includes a destination identifier field 178 for storing an identifier of a destination for the downlink signal, and a message field 180 storing the message received at 170 (shown in FIG. 3). Downlink signals in the embodiment shown are therefore digital data packets. However, in alternate embodiments, downlink signals may be analog signals or digital data stream signals that are not transmitted as digital data packets, for example.

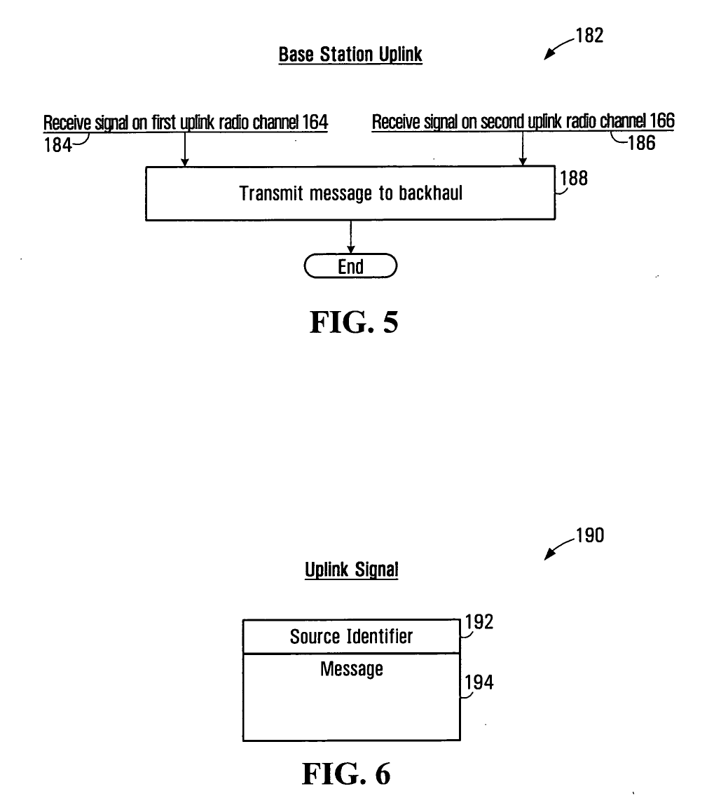

Referring back to FIG. 2, the program memory 146 also includes uplink codes 182 for directing the microprocessor 144 (shown in FIG. 2) to receive an uplink signal from one of the radio signal repeaters 104, 106, 108, 110, and 112 (shown in FIG. 1) in the embodiment shown. Referring to FIG. 5, the uplink codes 182 are illustrated schematically and begin either at 184 in response to an uplink signal received on the first uplink radio channel 164 at the radio antenna 154 (shown in FIG. 2) or at 186 in response to an uplink signal received on the second uplink radio channel 166 at the radio antenna (154). In either case, the uplink codes 182 continue at block 188, which directs the microprocessor (144) to transmit the message encoded in the signal that was received at either 184 or 186 to the backhaul 158 (shown in FIG. 2). Therefore, referring back to FIG. 1, in the embodiment shown the base station 102 receives uplink signals on the first and second uplink radio channels 164 and 166 from the radio signal repeaters 104, 106, 108, 110, and 112, and transmits messages encoded in those uplink signals to the backhaul 158 (shown in FIG. 2).

Referring to FIG. 6, an exemplary uplink signal received at 184 or 186 (shown in FIG. 5) is shown generally at 190, and includes a source identifier field 192 for storing an identifier of a source (such as one of the mobile stations 134, 136, 138, and 140 shown in FIG. 1, for example) of an uplink message, and a message field 194 for storing the message. An uplink message in the uplink message field 194 may include data for voice communication or other data, for example. Also, in the embodiment shown, the uplink signal 190 is a digital packet, but in alternative embodiments, uplink signals may include analog signals or digital data stream signals that are not divided into packets, for example.

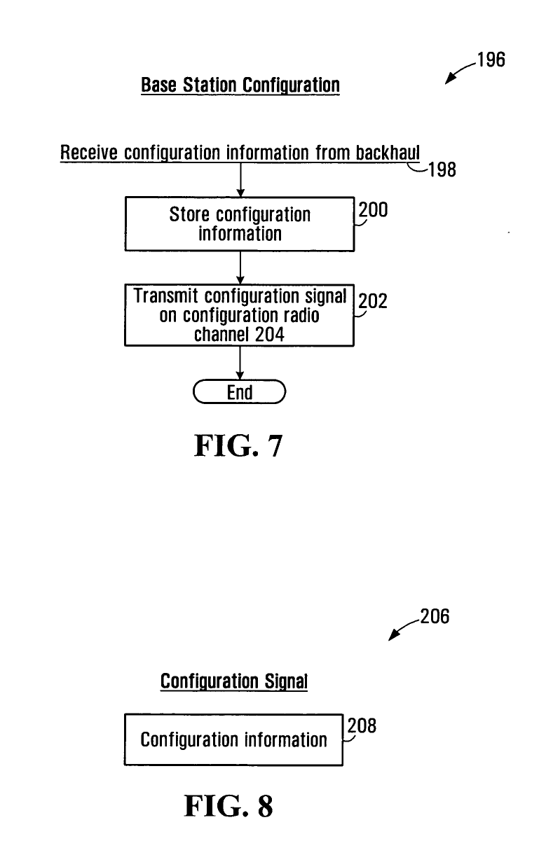

Referring back to FIG. 2, the program memory 146 also includes configuration codes 196 for directing the microprocessor 144 (shown in FIG. 2) to receive and transmit configuration information. Herein, “configuration information” may also refer to control information, and a “configuration signal” may also refer to a signal including control information. Referring to FIG. 7, the configuration codes 196 in the embodiment shown begin at 198 in response to receiving configuration information from the backhaul 158 (shown in FIG. 2). Configuration information received at 198 may include configuration information specifying multiplexing techniques, frequency bands for the radio channels 160, 162, 164, 166, and 204, and generally other configuration information for the radio communication system 100 (shown in FIG. 1), for example. The configuration codes 196 continue at block 200, which directs the microprocessor 144 (shown in FIG. 1) to store the configuration information received at 198 in the configuration memory 150 (shown in FIG. 2). The configuration codes 196 continue at block 202, which directs the microprocessor (144) to transmit a configuration signal encoded with the configuration information on the configuration and control radio channel 204.

As indicated above, the configuration and control radio channel 204 in the embodiment shown is also between about 57 GHz and about 64 GHz, but is in a frequency band different from frequency bands of the radio channels 160, 162, 164, and 166. Therefore, in the embodiment shown, configuration information is sent in a different radio frequency band from uplink and downlink signals, which may advantageously permit greater flexibility for timing configuration signals in some embodiments. Alternatively, the configuration and control radio channel 204 could be multiplexed in the same radio frequency bands as the radio channels 160, 162, 164, and 166, for example.

Referring to FIG. 8, an exemplary configuration signal transmitted at block 202 (shown in FIG. 7) is shown generally at 326, and includes a configuration information field 208 for storing configuration information such as the configuration information received at 198 (shown in FIG. 7).

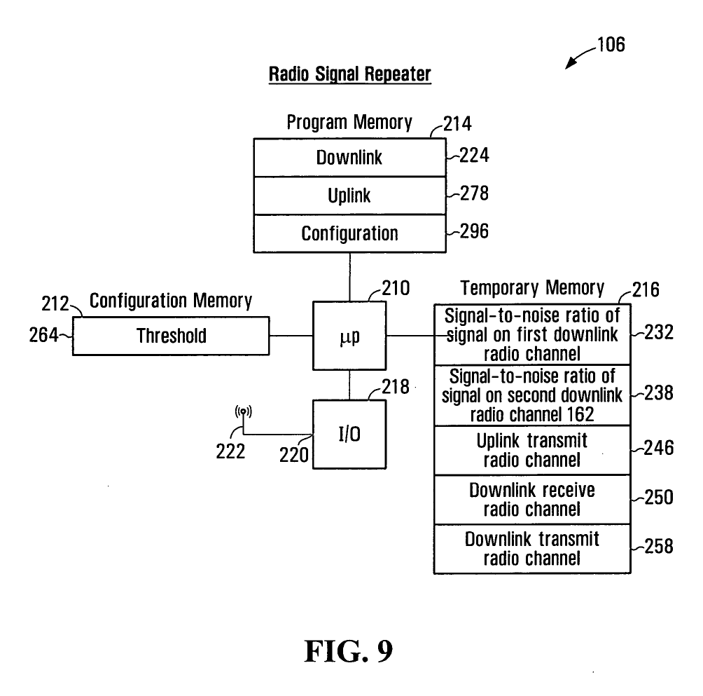

Referring to FIG. 9, the radio signal repeater 106 (also shown in FIG. 1) is shown schematically and in the embodiment shown includes a microprocessor 210 and configuration memory 212, program memory 214, temporary memory 216, and an I/O module 218 all in communication with the microprocessor 210. The configuration memory 212 in the embodiment shown includes RAM and stores information for configuring the radio signal repeater 106 such as configuration information received in the configuration signal 206 (shown in FIG. 8), for example. The program memory 214 in the embodiment shown also includes RAM and stores codes generally for directing the microprocessor 210 to carry out functions of the radio signal repeater 106. The temporary memory 216 in the embodiment shown includes RAM and stores various data that are generated and accessed during operation of the radio signal repeater 106. The I/O module 218 includes a radio antenna port 220 in communication with a radio antenna 222, and in the embodiment shown the radio antenna 222 facilitates radio communication with the base station 102 and with the radio signal repeaters 118 and 120 (shown in FIG. 1) over the radio channels 160, 162, 164, 166, and 204. The radio antenna 222 thus functions as a radio communications interface, or simply as an interface, for radio communication with the base station (102) and with the radio signal repeaters (118 and 120). Although the radio signal repeater 106 is illustrated in the embodiment shown with the microprocessor 210, the configuration memory 212, the program memory 214, the temporary memory 216, and the I/O module 218, alternative radio signal repeaters may include different components such as hard drives and ASICs, for example.

The program memory 214 includes downlink codes 224 generally for directing the microprocessor 210 to respond to a downlink signal transmitted by the base station 102 (shown in FIG. 1) at block 172 or 174 (shown in FIG. 3) in the embodiment shown.

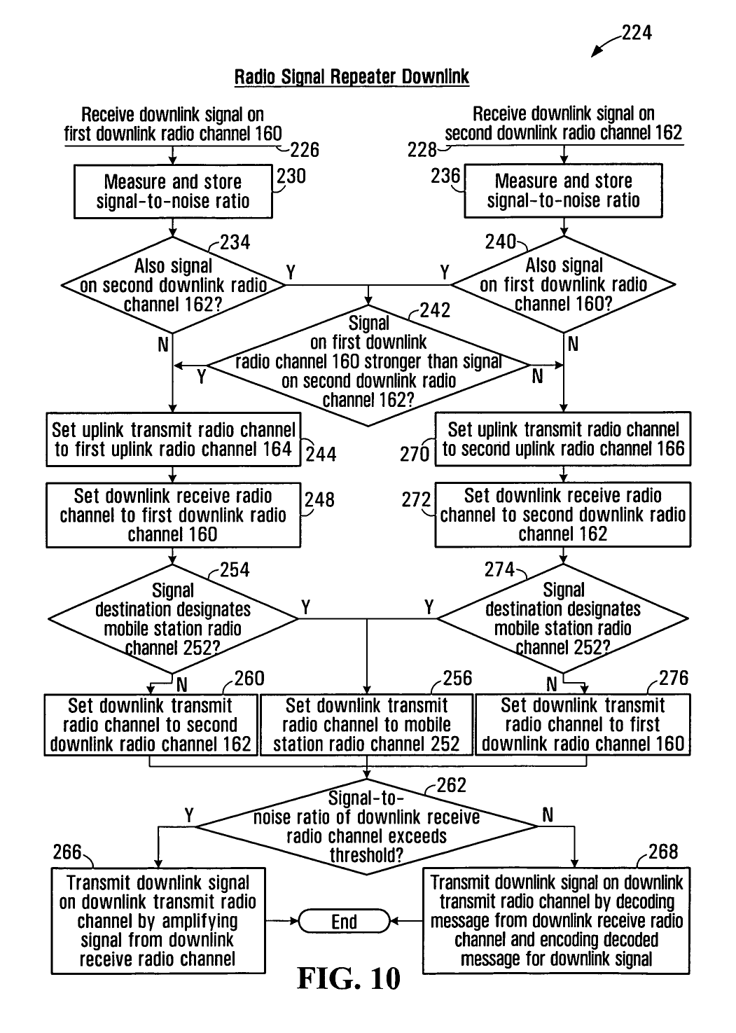

Referring to FIG. 10, the downlink codes 224 are illustrated schematically and begin either at 226 in response to receiving a downlink signal 176 (shown in FIG. 4) at the radio antenna 222 (shown in FIG. 9) on the first downlink radio channel 160 in response to the codes at block 172 (shown in FIG. 3), or at 228 in response to receiving a downlink signal (176) on the second downlink radio channel 162 in response to the codes at block 174 (shown in FIG. 3).

If the downlink codes 224 begin at 226, then the downlink codes 224 continue at block 230, which directs the microprocessor 210 (shown in FIG. 9) to measure a signal-to-noise ratio of the signal received on the first downlink radio channel 160, and to store the signal-to-noise ratio in a first signal-to-noise ratio store 232 in the temporary memory 216 (shown in FIG. 9). The downlink codes 224 continue at block 234, which directs the microprocessor (210) to determine whether a signal encoded with the same data was also received on the second downlink radio channel 162. A signal encoded with the same data may also be received on the second downlink radio channel 162 in response to the codes at block 174 (shown in FIG. 3).

If at block 234 a signal encoded with the same data was also received on the second downlink radio channel 162, then the downlink codes 224 also begin at 228 and continue at block 236, which directs the microprocessor (210) to measure a signal-to-noise ratio of the signal on the second downlink radio channel 162, and to store the signal-to-noise ratio in a second signal-to-noise ratio store 238 in the temporary memory 216 (shown in FIG. 9). The downlink codes 224 continue from block 236 to block 240, which directs the microprocessor (210) to determine whether a signal encoded with the same data was also received on the first downlink radio channel 160.

If at block 234 a signal encoded with the same data was also received on the second downlink radio channel 162, or if at block 240 a signal encoded with the same data was also received on the first downlink radio channel 160, then the downlink codes 224 continue at block 242, which directs the microprocessor (210) to determine whether the signal on the first downlink radio channel 160 was stronger than the signal on the second downlink radio channel 162. In the embodiment shown, the codes at block 242 direct the microprocessor (210) to compare the signal-to-noise ratios stored in the first and second signal-to-noise ratio stores 232 and 238 (shown in FIG. 9), and the microprocessor (210) determines that the signal on the first downlink radio channel 160 is stronger than the signal on the second downlink radio channel 162 if the first signal-to-noise ratio store (232) stores a greater signal-to-noise ratio than the second signal-to-noise ratio store (238).

If at block 242 the signal on the first downlink radio channel 160 is stronger than the signal on the second downlink radio channel 162, or if at block 234 there is no signal encoded with the same data on the second downlink radio channel 162, then the downlink codes 224 continue at block 244, which directs the microprocessor (210) to configure an uplink transmit radio channel. store 246 in the temporary memory 216 (shown in FIG. 9) to set the first uplink radio channel 164 as the uplink transmit radio channel. The downlink codes 224 continue at block 248, which directs the microprocessor (210) to configure a downlink receive radio channel store 250 in the temporary memory 216 (shown in FIG. 9) to set the first downlink radio channel 160 as the downlink receive radio channel.

Referring back to FIG. 1, in the embodiment shown the radio signal repeater 106 is in radio communication with the mobile station 134 on a mobile station radio channel 252. In the embodiment shown, the radio channels 160. 162, 164, 166, and 204 are in the 60 GHz band, whereas the mobile station radio channel 252 is in a GSM radio band at about 2 GHz. In alternative embodiments, radio signal repeaters may communicate with mobile stations in various radio frequency bands such as radio frequency bands for GSM, CDMA, TDMA, and IEEE 802.11 or 802.16, for example, and such mobile station radio channels will generally be in lower radio frequencies than the radio frequencies of the radio channels 160, 162, 164, 166, and 204 in the embodiment shown.

Referring back to FIG. 10, the downlink codes 224 continue from block 248 to block 254, which directs the microprocessor (210) to determine whether the destination identifier in the destination identifier field 178 (shown in FIG. 4) of the signal received at 226 designates a downlink radio channel in the mobile station radio channel 252. In the embodiment shown, the destination identifier in the destination identifier field (178) designates a downlink radio channel in the mobile station radio channel 252 if the destination identifier in the destination identifier field (178) designates a mobile station in radio communication with the radio signal repeater (106) on the mobile station radio channel 252, such as the mobile station 134 shown in FIG. 1 in the embodiment shown. If at block 254 the destination identifier in the destination identifier field (178) designates a downlink radio channel in the mobile station radio channel 252, then the downlink codes 224 continue at block 256, which directs the microprocessor (210) to configure a downlink transmit radio channel store 258 in the temporary memory 216 (shown in FIG. 9) to set the mobile station radio channel 252 as the downlink transmit radio channel. Otherwise, the downlink codes 224 continue at block 260, which directs the microprocessor (210) to configure the downlink transmit radio channel store (258) to set the second downlink radio channel 162 as the downlink transmit radio channel.

After either block 256 or 260, the downlink codes 224 continue at block 262, which directs the microprocessor (210) to determine whether the signal-to-noise ratio of the downlink receive radio channel exceeds a threshold stored in a threshold store 264 in the configuration memory 212 (shown in FIG. 9). If the downlink receive radio channel was set as the first downlink radio channel 160 at block 248, then the codes at block 262 compare the signal-to-noise ratio stored in the first signal-to-noise ratio store 232 to the threshold stored in the threshold store 264. If at block 262 the signal-to-noise ratio of the downlink receive radio channel exceeds the threshold, then the downlink codes 224 continue at block 266, which directs the microprocessor 210 to cause the radio antenna 222 (shown in FIG. 9) to transmit a downlink signal on the downlink transmit radio channel (specified by the downlink transmit radio channel store 258 shown in FIG. 9) by amplifying the signal received from the downlink receive radio channel (specified by the downlink receive radio channel store 250). However, if at block 262 the signal-to-noise ratio of the downlink receive radio channel does not exceed the threshold, then the downlink codes 224 continue at block 268, which directs the microprocessor (210) to cause the radio antenna (222) to transmit a downlink signal (176) on the downlink transmit radio channel (specified by the downlink transmit radio channel store 258 shown in FIG. 9) by digitally decoding the message received from the downlink receive radio channel (specified by the downlink receive radio channel store 250) and encoding the decoded message for the downlink signal. After either block 266 or block 268, the downlink codes 224 end.

Therefore, in the embodiment shown, the radio signal repeater (106) can repeat a received message either by simply amplifying the received uplink signal (as at block 266), or by digitally decoding and then encoding the received message (as at block 268). Where the signal-to-noise ratio of the received signal is above a threshold, the radio signal repeater (106) may simply amplify the signal, as a signal with a higher signal-to-noise ratio may be expected to have fewer errors. However, where the signal-to-noise ratio is below the threshold, then the signal is more likely to include errors, and digitally decoding and encoding the message may advantageously enhance the quality of the repeated signal, particularly if the signal includes redundant data-correction information, for example. In alternative embodiments, the codes at block 262 may be omitted, and the downlink codes 224 may proceed directly to either the codes at block 266 or to the codes at block 268, for example. In still other embodiments, the configuration memory 212 (shown in FIG. 9) may include configuration information determining whether to execute the codes at block 266 or the codes at block 268. Further, in embodiments where the downlink and uplink signals are purely analog, then the codes of blocks 262 and 268 may be omitted such that the downlink codes 224 proceed directly to the codes at block 266.

Still referring to FIG. 10, if at block 240 a signal encoded with the same data was not also received on the first downlink radio channel 160, or if at block 242 the signal on the first downlink radio channel 160 was not stronger than the signal on the second downlink radio channel 162, then the downlink codes 224 continue at block 270, which directs the microprocessor (210) to configure the uplink transmit radio channel store 246 (shown in FIG. 9) to set the second uplink radio channel 166 as the uplink transmit radio channel.

The downlink codes 224 continue at block 272, which directs the microprocessor (210) to configure the downlink receive radio channel store 250 (shown in FIG. 9) to set the second downlink radio channel 162 as the downlink receive radio channel.

The downlink codes 224 continue at block 274, which directs the microprocessor (210) to determine whether the destination identifier in the destination identifier field 178 of the downlink signal 176 (shown in FIG. 4) received at 228 designates a downlink radio channel in the mobile station radio channel 252. The codes at block 274 are therefore substantially the same as the codes at block 254, except that the codes at block 254 direct the microprocessor (210) to respond to the destination identifier in the destination identifier field (178) of a downlink signal (176) received at 226, and the codes at block 274 direct the microprocessor (210) to respond to the destination identifier in the destination identifier field (178) of a downlink signal (176) received at 228. If at block 274 the destination identifier in the destination identifier field (178) designates a downlink radio channel in the mobile station radio channel 252, then the downlink codes 224 continue at block 256 as discussed above. Otherwise, the downlink codes 224 continue at block 276, which directs the microprocessor (210) to configure the downlink transmit radio channel store 258 (shown in FIG. 9) to set the first downlink radio channel 160 as the downlink transmit radio channel. The downlink codes 224 then continue at block 262 as described above, except that if the downlink receive radio channel was set as the second downlink radio channel 162 at block 272, then the codes at block 262 compare the signal-to-noise ratio stored in the second signal-to-noise ratio store 238 (shown in FIG. 9) to the threshold stored in the threshold store 264 (shown in FIG. 9).

Referring back to FIG. 1, the radio signal repeater 106 in the embodiment shown may also receive uplink signals from the radio signal repeaters 118 and 120 or from the mobile stations 134 and 136. Referring to FIGS. 1 and 9, the program memory 214 also includes uplink codes 278 generally for directing the microprocessor 210 to respond to an uplink signal 190 (shown in

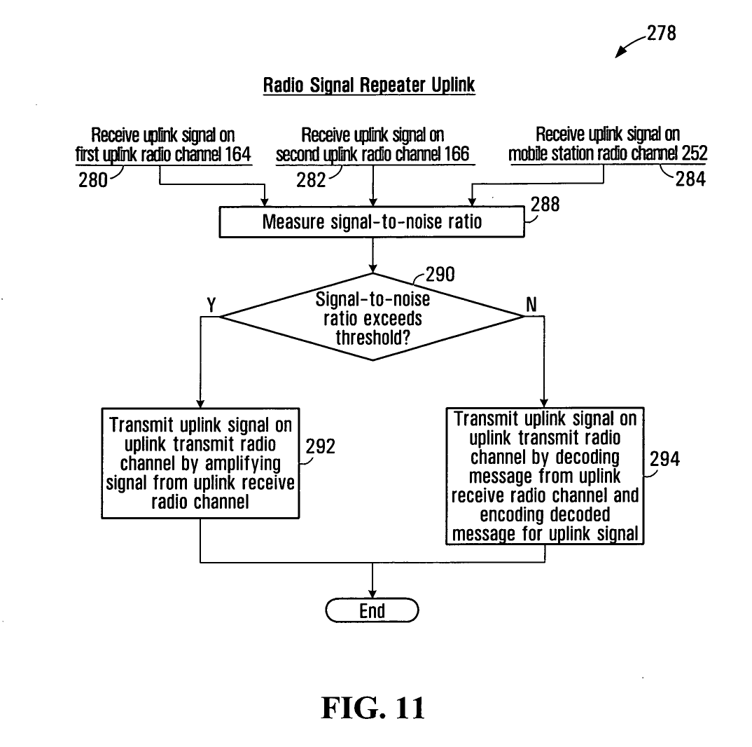

FIG. 6) from one of the radio signal repeaters 118 and 120 or from one of the mobile stations 134 and 136 in the embodiment shown. Referring to FIG. 11, the uplink codes 278 are illustrated schematically and begin at one of: 280 in response to receiving an uplink signal (190) at the radio antenna 222 (shown in FIG. 9) on the first uplink radio channel 164; 282 in response to receiving an uplink signal (190) at the radio antenna (222) on the second uplink radio channel 166; and 284 in response to receiving an uplink signal (190) at the radio antenna (222) on the mobile station radio channel 252.

After either 280, 282, or 284, the uplink codes 278 continue at block 288, which directs the microprocessor (210) to measure a signal-to-noise ratio of the uplink signal received at 280, 282, or 284. The uplink codes 278 continue at block 290, which directs the microprocessor (210) to determine whether the signal-to-noise ratio determined that block 288 exceeds the threshold stored in the threshold store 264 (shown in FIG. 9). If at block 290 the signal-to-noise ratio exceeds the threshold, then the uplink codes 278 continue at block 292, which directs the microprocessor (210) to transmit an uplink signal 190 (shown in FIG. 6) on the uplink transmit radio channel (specified by the uplink transmit radio channel store 246 shown in FIG. 9) by amplifying the signal received at 280, 282, or 284. Otherwise, the uplink codes 278 continue at block 294, which directs the microprocessor (210) to transmit an uplink signal (190) on the uplink transmit radio channel (specified by the uplink transmit radio channel store 246) by digitally decoding the message received at 280, 282, or 284, and then encoding the decoded message.

Therefore, as discussed above with respect to blocks 262, 266, and 268 (shown in FIG. 10), the codes at blocks 290, 292, and 294 cause the microprocessor (210) simply to amplify a received uplink signal if the signal-to-noise ratio of the received uplink signal exceeds a threshold, but to digitally decode and encode the received message if the signal-to-noise ratio of the received uplink signal is less than the threshold, as a signal received with a lower signal-to-noise ratio is likely to have additional errors that may be removed by digitally decoding and encoding the message. Again, in alternative embodiments, the codes at block 290 may be omitted, and the uplink codes 278 may proceed directly to either the codes at block 292 or to the codes at block 294, for example. In still other embodiments, the configuration memory 212 (shown in FIG. 9) may include configuration information determining whether to execute the codes at block 292 or the codes at block 294. Further, in embodiments where the downlink and uplink signals are purely analog, then the codes of blocks 290 and 294 may be omitted such that the uplink codes 278 proceed directly to the codes at block 292.

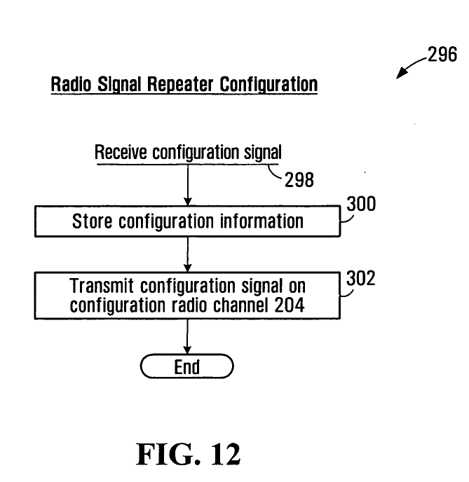

Referring back to FIG. 9, the program memory 214 also includes configuration codes 296 generally for directing the microprocessor 210 to respond to a configuration signal 206 (shown in FIG. 8) transmitted in response of the codes at block 202 (shown in FIG. 7), for example. Referring to FIG. 12, the configuration codes 296 are illustrated schematically and begin at 298 in response to receiving a configuration signal (206) at the radio antenna 222 (shown in FIG. 9). The configuration codes 296 continue at block 300, which direct the microprocessor 210 (shown in FIG. 9) to store the configuration information of the configuration information field 208 (shown in FIG. 8) of the configuration signal (206) received at 298 in the configuration memory 212 (shown in FIG. 9). The configuration codes 296 continue at block 302, which directs the microprocessor (210) to cause the radio antenna (222) to transmit a configuration signal (206) on the configuration and control radio channel 204. In the embodiment shown, the codes at block 302 cause the radio signal repeater 106 to transmit the configuration signal (206) to the radio station repeaters 118 and 120 shown in FIG. 1.

Referring back to FIG. 1, the radio signal repeaters 104, 108, 110, 112, 114, 116, 118, 120, 122, 124, 126, 128, 130, and 132 are substantially the same as the radio signal repeater 106 in the embodiment shown. However, in operation, the radio signal repeaters 104, 108, 110, 112, 114, 116, 118, 120, 122, 124, 126, 128, 130, and 132 in the embodiment shown communicate by radio with other such radio stations as shown in FIG. 1 and described above.

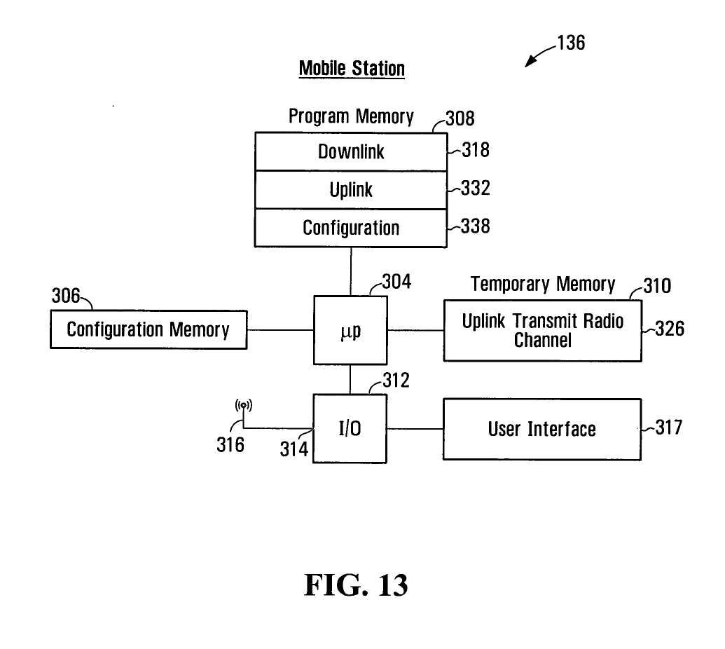

Referring to FIG. 13, the mobile station 136 is illustrated schematically and in the embodiment shown includes a microprocessor 304 and configuration memory 306 for storing configuration information for the mobile station 136, program memory 308 generally for directing the microprocessor 304 to carry out functions of the mobile station 136, temporary memory 310 for storing data generated and accessed during operation of the mobile station 136, and an I/O module 312, all in communication with the microprocessor 304. The configuration memory 306, the program memory 308, and the temporary memory 310 in the embodiment shown are RAM, and the I/O module 312 includes a radio antenna port 314 for communicating with a radio antenna 316. The mobile station 136 also includes a user interface 317 in communication with the I/O module 312. The user interface 317 represents various I/O components for interacting with a user of the mobile station 136, and in the embodiment shown includes a screen, a microphone, a speaker, and a keypad (all not shown).

Referring to FIGS. 1 and 13, the radio antenna 316 in the embodiment shown facilitates radio communication with the radio signal repeaters 106 and 120. However, unlike the mobile station 134, the mobile station 136 is in radio communication with the radio signal repeaters 106 and 120 on the radio channels 160, 162, 164, 166, and 204. In alternative embodiments, the mobile station 136 may be in radio communication with other radio signal repeaters or base stations, and more generally the radio antenna 316 functions as a radio communication interface, or simply an interface, for radio communication with radio signal repeaters such as the radio signal repeaters 106 and 120.

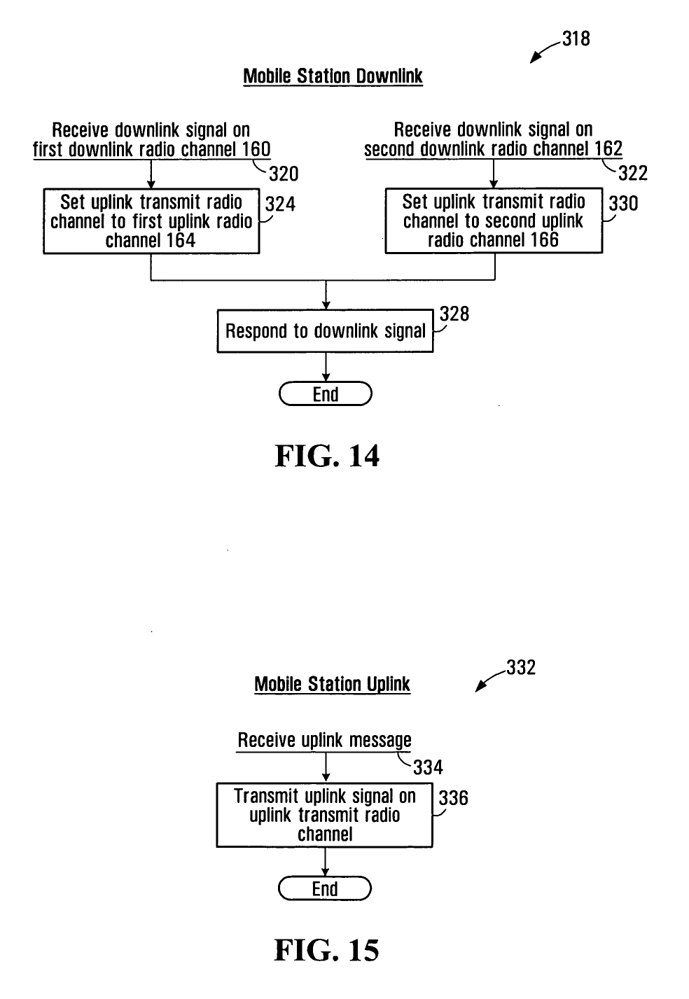

Referring back to FIG. 13, the program memory 308 includes downlink codes 318 generally for directing the microprocessor 304 to respond to a downlink signal 176 (shown in FIG. 4) transmitted in response to the codes at block 266 or 268 (shown in FIG. 10) in the embodiment shown. Referring to FIG. 14, the downlink codes 318 are illustrated schematically and begin either at 320 in response to receiving a downlink signal (176) at the radio antenna 316 (shown in FIG. 13) on the first downlink radio channel 160, or at 322 in response to receiving a downlink signal (176) at the radio antenna (316) on the second downlink radio channel 162. If the downlink codes 318 begin at 320, then the downlink codes 318 continue at block 324, which directs the microprocessor 304 (shown in FIG. 13) to configure an uplink transmit radio channel store 326 in the temporary memory 310 (shown in FIG. 13) to set the first uplink radio channel 164 as the uplink transmit radio channel. The codes at block 324 direct the microprocessor (304) to set the first uplink radio channel 164 as the uplink transmit radio channel in response to a downlink signal received on the first downlink radio channel 160, and the first uplink radio channel 164 is thus associated with the first downlink radio channel 160.

The downlink codes 318 continue at block 328, which directs the microprocessor (304) to respond to the downlink signal (176) received at 320 or 322. For example the downlink signal (176) received at 320 or 322 may include a message for voice communication or for other data transmission, and the codes at block 328 generally direct the microprocessor (304) to respond to the message accordingly.

However, if the downlink codes 318 begin at 322, then the downlink codes 318 continue at block 330, which directs the microprocessor (304) to configure the uplink transmit radio channel store (326) to set the second uplink radio channel 166 as the uplink transmit radio channel. The codes at block 330 direct the microprocessor (304) to set the second uplink radio channel 166 as the uplink transmit radio channel in response to a downlink signal received on the second downlink radio channel 162, and the second uplink radio channel 166 is thus associated with the second downlink radio channel 162. The downlink codes 318 then continue at block 328 as described above.

Referring back to FIG. 13, the program memory 308 also includes uplink codes 332 generally for directing the microprocessor 304 to transmit an uplink signal 190 (shown in FIG. 6). Referring to FIG. 15, the uplink codes 332 are illustrated schematically and begin at 334 in response to receiving an uplink message. The uplink message received at 334 may include uplink data for voice communication or other data communicated from the mobile station (136), for example. The uplink codes 332 continue at block 336, which direct the microprocessor 304 (shown in FIG. 13) to transmit an uplink signal (190) including the uplink message received at 334 in the message field 194 (shown in FIG. 6) of the uplink signal (190) on the uplink transmit radio channel specified by the uplink transmit radio channel store 326 (shown in FIG. 13). The uplink codes 332 then end.

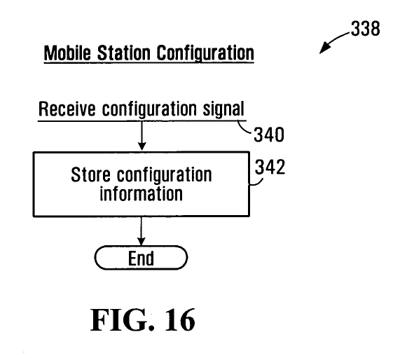

Referring back to FIG. 13, the program memory 308 also includes configuration codes 338 generally for directing the microprocessor 304 to respond to a configuration signal 206 (shown in FIG. 8) received at the radio antenna 316 on the configuration and control radio channel 204 in response to the codes at block 202 (shown in FIG. 7), for example. Referring to FIG. 16, the configuration codes 338 are illustrated schematically and begin at 340 in response to receiving the configuration signal (206) from the radio antenna (316). The configuration codes 338 continue at block 342, which directs the microprocessor 304 (shown in FIG. 13) to store configuration information from the configuration information field 208 of the configuration signal 206 (shown in FIG. 8) received at 340 in the configuration memory 306 (shown in FIG. 13). The configuration codes 338 then end.

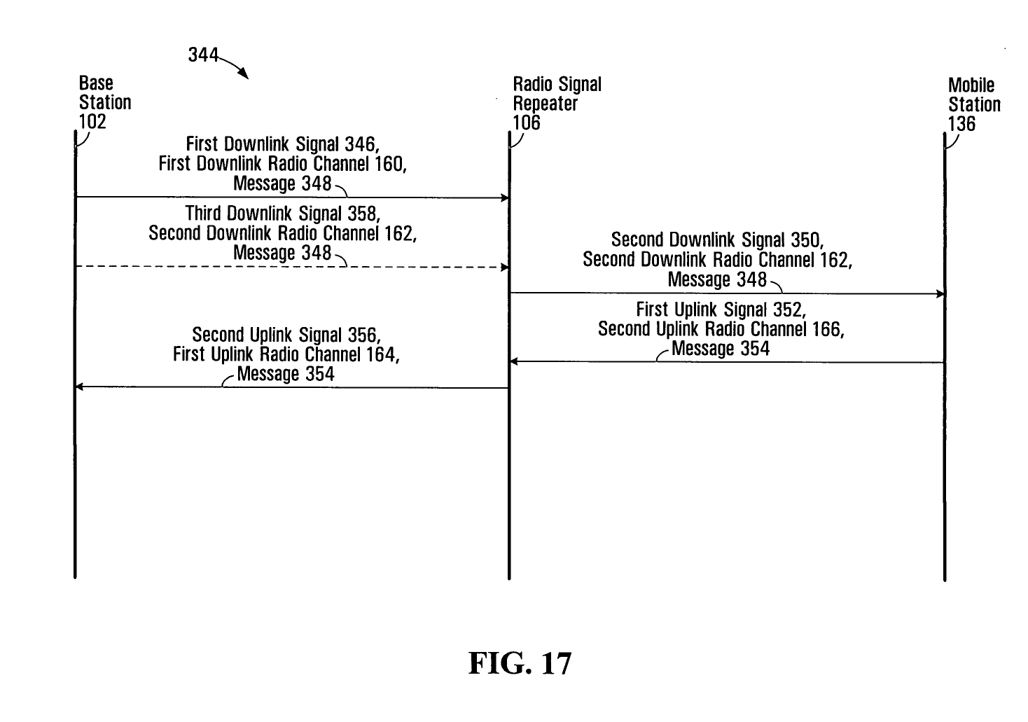

Referring to FIG. 17, an illustrative sequence of signals transmitted and received in the radio communication system 100 (shown in FIG. 1) is illustrated schematically and shown generally at 344. The sequence of signals 344 begins when the base station 102 transmits a first downlink signal 346 on the first downlink radio channel 160 encoded with a first message 348 in response to the codes of block 172 of the downlink codes. 168 (shown in FIG. 3). The radio signal repeater 106 receives the first downlink signal 346 and transmits a second downlink signal 350 on the second downlink radio channel 162 encoded with the first message 348 in response to the codes at blocks 230, 234, 244, 248, 254, 260, 262, and either 266 or 268 of the downlink codes 224 (shown in FIG. 10). The mobile station 136 receives the second downlink signal 350 in response to the codes at blocks 330 and 328 of the downlink codes 318 (shown in FIG. 14). The mobile station 136 then transmits a first uplink signal 352 encoded with a second message 354 on the second uplink radio channel 166 in response to the codes at block 336 of the uplink codes 332 (shown in FIG. 15). Then the radio signal repeater 106 receives the first uplink signal 352 and transmits a second uplink signal 356 on the first uplink radio channel 164 encoded with the second message 354 in response to the uplink codes 278 (shown in FIG. 11). The base station 102 then receives the second uplink signal 356 in response to the uplink codes 182 (shown in FIG. 5).

In summary, in the sequence of signals 344, the radio signal repeater 106: receives, from the base station 102, the first downlink signal 346 encoded with the first message 348 on the first downlink radio channel 160; after receiving the first downlink signal 346, transmits, to the mobile station 136, the second downlink signal 350 encoded with the first message 348 on the second downlink radio channel 162; receives, from the mobile station 136, the first uplink signal 352 encoded with the second message 354 on the second uplink radio channel 166; and after receiving the first uplink signal 352, transmits, to the base station 102, the second uplink signal 356 encoded with the second message 354 on the first uplink radio channel 164.

In an alternative embodiment also shown on FIG. 17, the base station 102 also transmits a third downlink signal 358 on the second downlink radio channel 162 and encoded with the first message 348, and the radio signal repeater 106 receives the third downlink signal 358 before transmitting the second downlink signal 350. However, in this alternative embodiment, the radio signal repeater 106 measures (at block 230 shown in FIG. 10) a higher signal-to-noise ratio of the first downlink signal 346 than for the third downlink signal 358 (measured at block 236 shown in FIG. 10). Therefore, at block 242 shown in FIG. 10, the radio signal repeater 106 determines that the first downlink signal 346 on the first downlink radio channel 160 is stronger than the third downlink signal 358 on the second downlink radio channel 162, and the downlink codes 224 therefore continue at blocks 244, 248, 254, 260, 262, and 266 or 268 (shown in FIG. 10) in this alternative embodiment. Therefore, in this alternative embodiment, the radio signal repeater 106 also receives, before transmitting the second radio signal (the second downlink signal 350), a fifth radio signal (the third downlink signal 358) encoded with the first message 348 on the second radio channel (the second downlink radio channel 162), but because the first signal (the first downlink signal 346) is stronger than the fifth signal (the third downlink signal 358), the codes at block 242 (shown in FIG. 10) cause the radio signal repeater 106 to select (at block 260 shown in FIG. 10) the second radio channel (the second downlink radio channel 162) instead of the first channel (the first downlink channel 160) for the second radio signal (the second downlink signal 350).

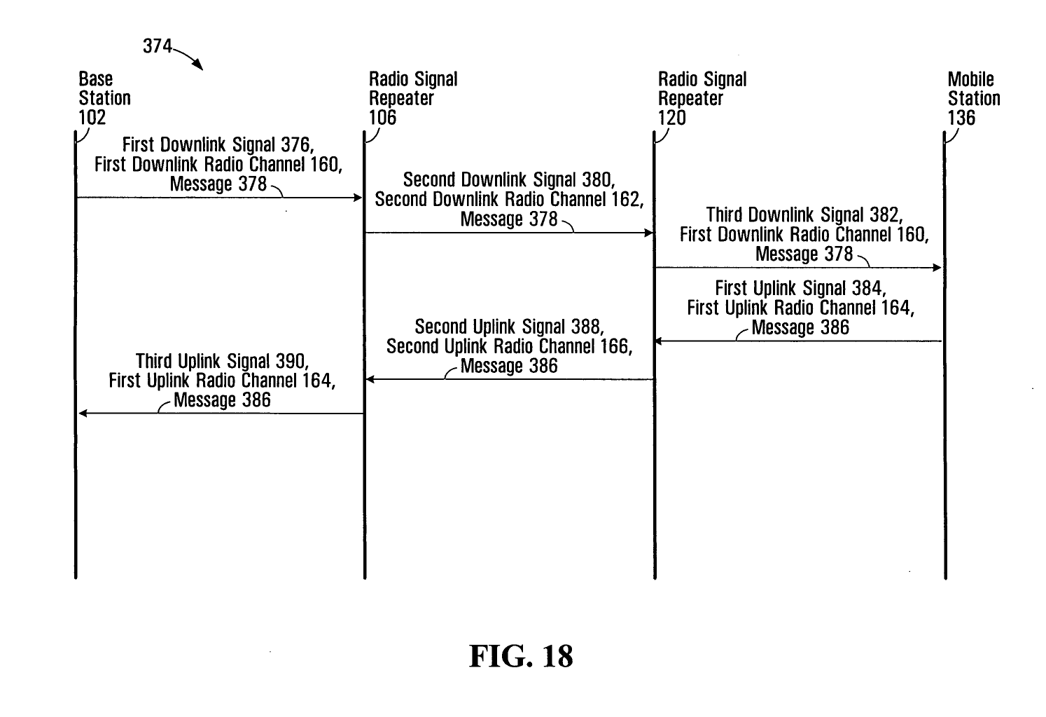

Referring back to FIG. 1, the mobile station 136 is also in radio communication with the radio signal repeater 120 on the radio channels 160, 162, 164, 166, and 204, and due to interference or other environmental conditions, for example, the mobile station 136 may lose radio communication with the radio signal repeater 106 and begin receiving downlink signals instead from the radio signal repeater 120. Referring to FIG. 18, another illustrative sequence of signals transmitted and received in the radio communication system 100 (shown in FIG. 1), where the mobile station 136 receives downlink signals from the radio signal repeater 120 instead of from the radio signal repeater 106, is illustrated schematically and shown generally at 374. The sequence of signals 374 begins when the base station 102 transmits a first downlink signal 376 on the first downlink radio channel 160 encoded with a first message 378. The radio signal repeater 106 receives the first downlink signal 346 and transmits a second downlink signal 380 on the second downlink radio channel 162 encoded with the first message 378. The radio signal repeater 120 receives the second downlink signal 376 and transmits a third downlink signal 382 on the first downlink radio channel 160 encoded with the first message 378. The mobile station 136 receives the third downlink signal 382 in response to the codes at blocks 324 and 328 of the downlink codes 318 (shown in FIG. 14). The mobile station 136 then transmits a first uplink signal 384 encoded with a second message 386 on the first uplink radio channel 164 in response to the codes at block 336 of the uplink codes 332 (shown in FIG. 15). Then the radio signal repeater 120 receives the first uplink signal 384 and transmits a second uplink signal 388 on the second uplink radio channel 166 encoded with the second message 386. Then the radio signal repeater 106 receives the second uplink signal 388 and transmits a third uplink signal 390 on the first uplink radio channel 164 encoded with the second message 386. The base station 102 then receives the third uplink signal 390.

In summary, in the sequence of signals 374, the radio signal repeater 120: receives the second downlink signal 380 from the radio signal repeater 106; after receiving the second downlink signal 380, transmits the third downlink signal 382 encoded with the first message 378 to the mobile station 136 on the first downlink radio channel 160; and before transmitting the second uplink signal 388, receives the first uplink signal 384 encoded with the second message 386 from the mobile station 136.

In summary, referring to FIGS. 17 and 18, in the sequences of signals 344 and 374, the mobile station 136: receives the second downlink signal 350 from the radio signal repeater 106 on the second downlink radio channel 162; transmits the first uplink signal 352 to radio signal repeater 106 on the second uplink radio channel 166 associated (by the codes at block 330 shown in FIG. 14) with the second downlink radio channel 162; receives the third downlink signal 382 from the radio signal repeater 120 on the first downlink radio channel 160; and transmits the first uplink signal 384 to the radio signal repeater 120 on the first uplink radio channel 164 associated (by the codes at block 324 shown in FIG. 14) with the first downlink radio channel 160.

In the illustrative embodiments shown in FIGS. 17 and 18, the radio signal repeaters communicate only in the radio channels 160, 162, 164, and 166, and therefore in such embodiments need not be configured to communicate in the mobile station radio channel 252. Therefore, in such embodiments, blocks 254, 256, and 274 (shown in FIG. 10) may be omitted.

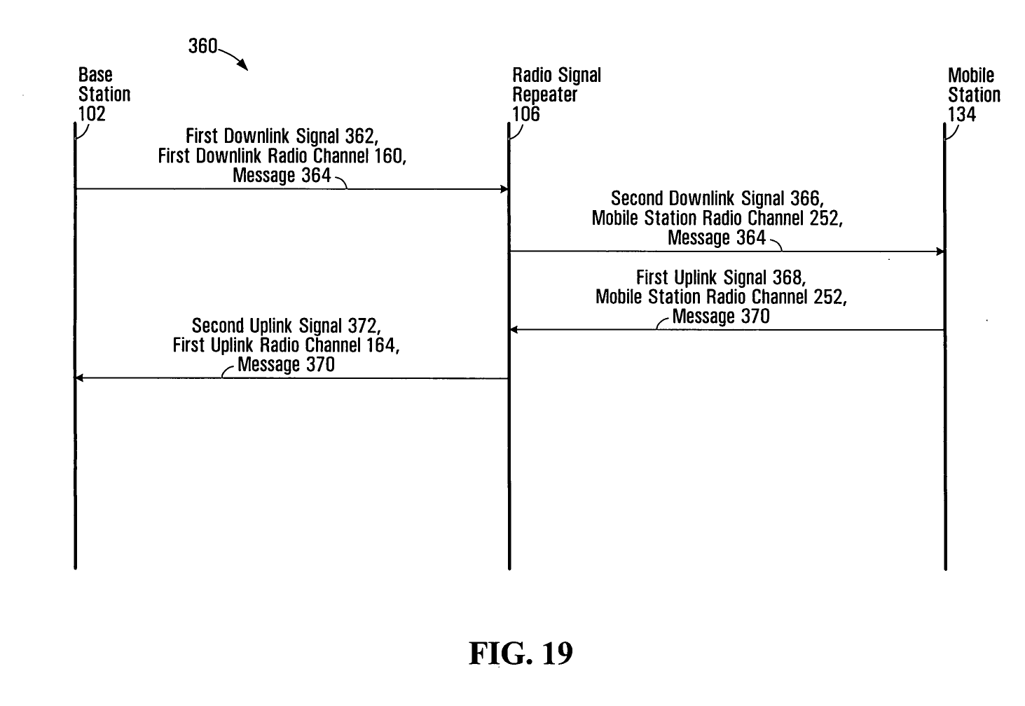

Referring to FIG. 19, another illustrative sequence of signals transmitted and received in the radio communication system 100 (shown in FIG. 1) is illustrated schematically and shown generally at 360. The sequence of signals 360 begins when the base station 102 transmits a first downlink signal 362 on the first downlink radio channel 160 and encoded with a first message 364. In the embodiment shown, the destination identifier in the destination identifier field 178 (shown in FIG. 4) of the first downlink signal 362 designates the mobile station 134, which is in radio communication with the radio signal repeater 106 over the mobile station radio channel 252 as shown in FIG. 1. Therefore, the radio signal repeater 106 receives the first downlink signal 362 and transmits a second downlink signal 366 encoded with the first message 364 on the mobile station radio channel 252 in response to the codes at block 254 shown in FIG. 10. The mobile station 134 receives the second downlink signal 366, and later transmits a first uplink signal 368 encoded with a second message 370 on the mobile station radio channel 252. The radio signal repeater 106 receives the first uplink signal 368 and transmits a second uplink signal 372 encoded with the second message 370 on the first uplink radio channel 164 in response to the uplink codes 278 (shown in FIG. 11). The base station 102 then receives the second uplink signal 372 in response to the uplink codes 182 (shown in FIG. 5).

In summary, in the illustrative sequence of signals 360, the radio signal repeater 106: receives the first downlink signal 362 encoded with the first message 364 on the first downlink radio channel 160; after receiving the first downlink signal 362, transmits, to the mobile station 134, the second downlink signal 366 encoded with the first message 364 on the mobile station radio channel 252; receives the first uplink signal 368 encoded with the second message 370 from the mobile station 134 on the mobile station radio channel 252; and after receiving the first uplink signal 368, transmits, to the base station 102, the second uplink signal 372 encoded with the second message 370 on the first uplink radio channel 164.

In the illustrative sequence of signals 360, the mobile station 134 communicates on the mobile station radio channel 252 with the radio signal repeater 106, and the mobile station 134 may thus be considered to be in a micro, pico, or femto cell of the radio signal repeater 106. In the embodiment shown, one or more of the radio signal repeaters 104, 106, 108, 110, 112, 114, 116, 118, 120, 122, 124, 126, 128, 130, and 132 may establish respective such micro, pico, or femto cells.

Referring back to FIG. 1, the mobile station 140 is in radio communication with the radio signal repeater 118 on the mobile station radio channel 252. In the embodiment shown, the configuration information received at 198 (shown in FIG. 7) and transmitted in the configuration information field 208 (shown in FIG. 8), for example, may configure the mobile stations 134 and 140 to be in radio communication with the radio signal repeaters 106 and 118 on respective different subchannels of the mobile station radio channel 252.

More generally, in the embodiment shown, the configuration information may associate various subchannels of the mobile station radio channel 252 with each of the radio signal repeaters 104, 106, 108, 110, 112, 114, 116, 118, 120, 122, 124, 126, 128, 130, and 132, and one or more mobile stations in radio communication with one of those radio signal repeaters may also be associated with the subchannel associated with the radio signal repeater. These different subchannels may be advantageous to reduce interference in transmissions from adjacent radio signal repeaters on the mobile station radio channel 252, for example.

The configuration information may also associate the subchannels of the mobile station radio channel 252 with respective subchannels in each of the radio channels 160, 162, 164, and 166. In such a configuration, the codes at blocks 172 and 174 (shown in FIG. 3) and at blocks 266 and 268 (shown in FIG. 10) transmit downlink signals 178 (shown in FIG. 4) in respective subchannels of the first and second downlink radio channels 160 and 162 that are associated with the destination mobile station of the downlink signals, and the codes at blocks 292 and 294 (shown in FIG. 11) and at block 336 (shown in FIG. 15) transmit uplink signals 190 (shown in FIG. 6) in respective subchannels of the first and second uplink radio channels 164 and 166 that are associated with the source mobile station of the uplink signals. Also in such a configuration, the destination identifier field 178 (shown in FIG. 4) and the source identifier field 192 (shown in FIG. 6) may be omitted because the destination or source of a signal may be identified by the subchannel of the downlink signal (178) or of the uplink signal (190), and the codes at blocks 254 and 274 (shown in FIG. 10) may determine whether the signal is designated for the mobile station radio channel 252 by identifying the subchannel of the transmit downlink signal (178) received at 226 or 228 (also shown in FIG. 10).

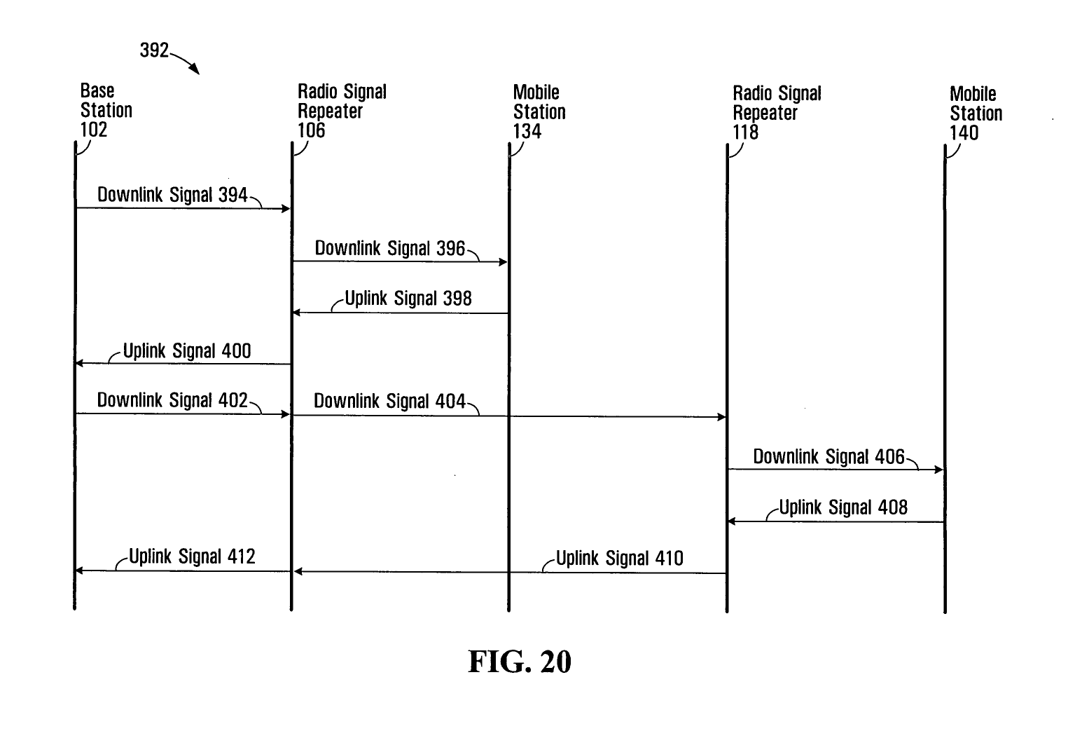

Referring to FIG. 20, another illustrative sequence of signals transmitted and received in the radio communication system 100 (shown in FIG. 1) is illustrated schematically and shown generally at 392. The sequence of signals 392 begins when the base station 102 transmits a first downlink signal 394 in a subchannel of the first downlink radio channel 160 associated with the mobile station 134. The radio signal repeater 106 receives the first downlink signal 394 and transmits a second downlink signal 396 to the mobile station 134 on a subchannel of the mobile station radio channel 252 associated with the mobile station 134. Later, the mobile station 134 transmits a first uplink signal 398 on the subchannel of the mobile station radio channel 252 associated with the mobile station 134, and the radio signal repeater 106 receives the first uplink signal 398 and transmits a second uplink signal 400 to the base station 102 on a subchannel of the first uplink radio channel 162 associated with the mobile station 134.

Later in the sequence of signals 392, the base station 102 transmits a third downlink signal 402 on a subchannel of the first downlink radio channel 160 associated with the mobile station 140. The radio signal repeater 106 receives the third downlink signal 402 and transmits a fourth downlink signal 404 on a subchannel of the second downlink radio channel 162 associated with the mobile station 140. The radio signal repeater 118 receives the fourth downlink signal 404 and transmits a fifth downlink signal 406 to the mobile station 140 on a subchannel of the mobile station radio channel 252 associated with the mobile station 140. Later, the mobile station 140 transmits a third uplink signal 408 on the subchannel of the mobile station radio channel 252 associated with the mobile station 140. The radio signal repeater 118 receives the third uplink signal 408 and transmits a fourth uplink signal 410 on a subchannel of the second uplink radio channel 166 associated with the mobile station 140. The radio signal repeater 106 receives the fourth uplink signal 410 and transmits a fifth uplink signal 412 on a subchannel of the first uplink radio channel 164 associated with the mobile station 140.

The radio communication system 100 may enable communication at higher radio frequencies, such as EHF frequencies for example, advantageously enabling greater operating bandwidth available in such higher radio frequencies. In practice, the base station 102 of the radio communication system 100 may replace an existing base station using only lower radio frequencies to upgrade the existing base station and provide greater operating bandwidth. Further, the radio signal repeaters described above may advantageously be positioned closer together, as may be required to accommodate the shorter range of higher radio frequencies, as the at least two different channels for uplink signals and the at least two different channels downlink signals may advantageously reduce interference between the signals.

While various embodiments have been described and illustrated, such embodiments should be considered illustrative only and not as limiting the invention as construed in accordance with the accompanying claims.

What is claimed is:

1. A method of facilitating radio communications, the method comprising:
receiving, at a radio signal repeater from a first remote radio station on a first radio channel, a first radio signal encoded with a first message;
after receiving the first radio signal, transmitting, from the radio signal repeater to a second remote radio station on a second radio channel different from the first radio channel, a second radio signal encoded with the first message;
receiving, at the radio signal repeater from the second remote radio station on a third radio channel different from the first and second radio channels, a third radio signal encoded with a second message; and
after receiving the third radio signal, transmitting, from the radio signal repeater to the first remote radio station on a fourth radio channel different from the first, second, and third radio channels, a fourth radio signal encoded with the second message.

2. The method of claim 1 wherein the first, second, third, and fourth radio channels are frequency-division multiplexed on first, second, third, and fourth different radio frequency bands respectively.

3. The method of claim 1 wherein the first and fourth radio channels are time-division multiplexed on a first radio frequency band, and wherein the second and third radio channels are time-division multiplexed on a second radio frequency band different from the first radio frequency band.

4. The method of claim 1 further comprising receiving, at the radio signal repeater, configuration information encoded in a configuration information signal in a configuration radio frequency band different from respective radio frequency bands of the first, second, third, and fourth radio channels.

5. The method of claim 4 wherein the configuration radio frequency band is between about 57 GHz and about 64 GHz.

6. The method of claim 1 wherein the first, second, third, and fourth radio channels have respective radio frequencies between about 57 GHz and about 64 GHz.

7. The method of claim 1 wherein transmitting the second radio signal comprises amplifying the first radio signal, and wherein transmitting the fourth radio signal comprises amplifying the third radio signal.

8. The method of claim 1 wherein transmitting the second radio signal comprises digitally decoding the first message from the first radio signal and encoding the decoded first message for the second radio signal, and wherein transmitting the fourth radio signal comprises digitally decoding the second message from the third radio signal and encoding the decoded second message for the fourth radio signal.

9. The method of claim 1 further comprising:
determining a first signal-to-noise ratio representing a ratio of strength of the first radio signal to noise in the first radio signal at the radio signal repeater; and
determining a second signal-to-noise ratio representing a ratio of strength of the third radio signal to noise in the third radio signal at the radio signal repeater;
wherein if the first signal-to-noise ratio satisfies a first criterion, transmitting the second radio signal comprises amplifying the first radio signal;
wherein if the first signal-to-noise ratio does not satisfy the first criterion, transmitting the second radio signal comprises digitally decoding the first message from the first radio signal and encoding the decoded first message for the second radio signal;
wherein if the second signal-to-noise ratio satisfies a second criterion, transmitting the fourth radio signal comprises amplifying the third radio signal; and
wherein if the second signal-to-noise ratio does not satisfy the second criterion, transmitting the fourth radio signal comprises digitally decoding the second message from the third radio signal and encoding the decoded second message for the fourth radio signal.

10. The method of claim 9 wherein:
the first signal-to-noise ratio satisfies the first criterion if the first signal-to-noise ratio exceeds a first threshold;
the first signal-to-noise ratio does not satisfy the first criterion if the first signal-to-noise ratio does not exceed the first threshold;
the second signal-to-noise ratio satisfies the second criterion if the second signal-to-noise ratio exceeds a second threshold; and
the second signal-to-noise ratio does not satisfy the second criterion if the second signal-to-noise ratio does not exceed the second threshold.

11. The method of claim 1 further comprising:
before transmitting the second radio signal, receiving, at the radio signal repeater from the first remote radio station on the second radio channel, a fifth radio signal encoded with the first message, the first radio signal being stronger than the fifth radio signal; and comparing respective signal strengths of the first and fifth radio signals to determine that the first radio signal is stronger than the fifth radio signal;
wherein transmitting the second radio signal comprises selecting the second radio channel instead of the first radio channel for the second radio signal in response to determining that the first radio signal is stronger than the fifth radio signal.

12. The method of claim 1 further comprising:
receiving, at the radio signal repeater from the first remote radio station on the first radio channel, a sixth radio signal encoded with a third message;
after receiving the sixth radio signal, transmitting, to a third remote radio station on a fifth radio channel different from the first, second, third, and fourth radio channels, a seventh radio signal encoded with the third message;
receiving, at the radio signal repeater from the third remote radio station on the fifth radio channel, an eighth radio signal encoded with a fourth message; and
after receiving the eighth radio signal, transmitting, to the first remote radio station on the fourth radio channel, a ninth radio signal encoded with the fourth message.

13. The method of claim 12 wherein the fifth radio channel has a radio frequency less than about 5 GHz.

14. The method of claim 12 wherein:
receiving the sixth radio signal comprises receiving the sixth radio signal on a subchannel of the first radio channel associated with the third remote radio station;
transmitting the seventh radio signal comprises transmitting the seventh radio signal on a subchannel of the fifth radio channel associated with the third remote radio station;
receiving the eighth radio signal comprises receiving the eighth radio signal on the subchannel of the fifth radio channel associated with the third remote radio station; and
transmitting the ninth radio signal comprises transmitting the ninth radio signal on a subchannel of the fourth radio channel associated with the third remote radio station.

15. The method of claim 12 wherein the sixth radio signal includes a destination field including destination data designating the third remote radio station.

16. The method of claim 1 further comprising:
receiving the second radio signal at the second remote radio station from the radio signal repeater; and
after receiving the second radio signal, transmitting, from the second remote radio station to a fourth remote radio station on the first radio channel, a tenth radio signal encoded with the first message.

17. The method of claim 16 further comprising, before transmitting the third radio signal, receiving, at the second remote station from the fourth remote station on the fourth radio channel, an eleventh radio signal encoded with the second message.

18. A radio signal repeater apparatus comprising:
means for receiving, from a first remote radio station on a first radio channel, a first radio signal encoded with a first message;
means for transmitting, after receiving the first radio signal, a second radio signal to a second remote radio station on a second radio channel different from the first radio channel, the second radio signal encoded with the first message;
means for receiving, from the second remote radio station on a third radio channel different from the first and second radio channels, a third radio signal encoded with a second message; and
means for transmitting, after receiving the third radio signal, a fourth radio signal to the first remote radio station on a fourth radio channel different from the first, second, and third radio channels, the fourth radio signal encoded with the second message.

19. A radio signal repeater apparatus comprising:
an interface for facilitating radio communication with first and second remote radio stations on first, second, third, and fourth different radio channels; and
a processor in communication with the interface and operably configured to:
receive, from the interface, a first radio signal from the first remote radio station on the first radio channel, the first radio signal encoded with a first message;
cause the interface to transmit, after receiving the first radio signal, a second radio signal to the second remote radio station on the second radio channel, the second radio signal encoded with the first message;
receive, from the interface, a third radio signal from the second remote radio station on the third radio channel, the third radio signal encoded with a second message; and
cause the interface to transmit, after receiving the third radio signal, a fourth radio signal to the first remote radio station on the fourth radio channel, the fourth radio signal encoded with the second message.

20. The apparatus of claim 19 wherein the first, second, third, and fourth radio channels are frequency-division multiplexed on first, second, third, and fourth different radio frequency bands respectively.

21. The apparatus of claim 19 wherein the first and fourth radio channels are time-division multiplexed on a first radio frequency band, and wherein the second and third radio channels are time-division multiplexed on a second radio frequency band different from the first radio frequency band.

22. The apparatus of claim 19 wherein the processor is further operably configured to receive, from the interface, configuration information encoded in a configuration information signal in a configuration radio frequency band different from respective radio frequency bands of the first, second, third, and fourth radio channels.

23. The apparatus of claim 22 wherein the configuration radio frequency band is between about 57 GHz and about 64 GHz.

24. The apparatus of claim 19 wherein the first, second, third, and fourth radio channels have respective radio frequencies between about 57 GHz and about 64 GHz.

25. The apparatus of claim 19 wherein:
the processor is operably configured to cause the interface to transmit the second radio signal by amplifying the first radio signal; and
the processor is operably configured to cause the interface to transmit the fourth radio signal by amplifying the third radio signal.

26. The apparatus of claim 19 wherein:
the processor is operably configured to cause the interface to transmit the second radio signal by digitally decoding the first message from the first radio signal and by encoding the decoded first message for the second radio signal; and
the processor is operably configured to cause the interface to transmit the fourth radio signal by digitally decoding the second message from the third radio signal and by encoding the decoded second message for the fourth radio signal.

27. The apparatus of claim 19 wherein:
the processor is further operably configured to determine a first signal-to-noise ratio representing a ratio of strength of the first radio signal to noise in the first radio signal at the interface;
the processor is operably configured to cause the interface to transmit the second radio signal by amplifying the first radio signal if the first signal-to-noise ratio satisfies a first criterion;
the processor is operably configured to cause the interface to transmit the second radio signal by digitally decoding the first message from the first radio signal and by encoding the decoded first message for the second radio signal if the first signal-to-noise ratio does not satisfy the first criterion;
the processor is further operably configured to determine a second signal-to-noise ratio representing a ratio of strength of the third radio signal to noise in the third radio signal at the interface;
the processor is operably configured to cause the interface to transmit the fourth radio signal by amplifying the third radio signal if the second signal-to-noise ratio satisfies a second criterion; and
the processor is operably configured to cause the interface to transmit the fourth radio signal by digitally decoding the second message from the third radio signal and by encoding the decoded second message for the fourth radio signal if the second signal-to-noise ratio does not satisfy the second criterion.

28. The apparatus of claim 27 wherein:
the first signal-to-noise ratio satisfies the first criterion if the first signal-to-noise ratio exceeds a first threshold;
the first signal-to-noise ratio does not satisfy the first criterion if the first signal-to-noise ratio does not exceed the first threshold;
the second signal-to-noise ratio satisfies the second criterion if the second signal-to-noise ratio exceeds a second threshold; and
the second signal-to-noise ratio does not satisfy the second criterion if the second signal-to-noise ratio does not exceed the second threshold.

29. The apparatus of claim 19 wherein the processor is further operably configured to:
receive from the interface, before transmitting the second radio signal, a fifth radio signal from the first remote radio station on the second radio channel, the fifth radio signal encoded with the first message and not as strong as the first radio signal;
compare respective signal strengths of the first and fifth radio signals; and
select the second radio channel instead of the first radio channel for the second radio signal if the first radio signal is stronger than the fifth radio signal.

30. The apparatus of claim 19 wherein the processor is further operably configured to:
receive, from the interface, a sixth radio signal from the first remote radio station on the first radio channel, the sixth radio signal encoded with a third message;
after receiving the sixth radio signal, cause the interface to transmit, to a third remote radio station on a fifth radio channel different from the first, second, third, and fourth radio channels, a seventh radio signal encoded with the third message;
receive, from the interface, an eighth radio signal from the third remote radio station on the fifth radio channel, the eighth radio signal encoded with a fourth message; and
after receiving the eighth radio signal, cause the interface to transmit, to the first remote radio station on the fourth radio channel, a ninth radio signal encoded with the fourth message.

31. The apparatus of claim 30 wherein the fifth radio channel has a radio frequency less than about 5 GHz.

32. The apparatus of claim 30 wherein:
the processor is operably configured to receive the sixth radio signal on a subchannel of the first radio channel associated with the third remote radio station;
the processor is operably configured to transmit the seventh radio signal on a subchannel of the fifth radio channel associated with the third remote radio station;
the processor is operably configured to receive the eighth radio signal on the subchannel of the fifth radio channel associated with the third remote radio station; and
the processor is operably configured to transmit the ninth radio signal on a subchannel of the fourth radio channel associated with the third remote radio station.

33. The apparatus of claim 30 wherein:
the sixth radio signal includes a destination field including destination data; and
the processor is operably configured to cause the interface to transmit the seventh radio signal in response to receiving the sixth radio signal when the destination field of the sixth radio signal includes destination data designating the third remote radio station.

34. A method of radio communication, the method comprising:
receiving a first radio signal at a mobile station from a first remote radio station on a first radio channel;
transmitting a second radio signal from the mobile station to the first remote radio station on a second radio channel associated with the first radio channel and different from the first radio channel;
receiving a third radio signal at the mobile station from a second remote radio station on a third radio channel different from the first and second radio channels; and
transmitting a fourth radio signal from the mobile station to the second remote radio station on a fourth radio channel associated with the third radio channel and different from the first, second, and third radio channels.

35. The method of claim 34 wherein the first, second, third, and fourth radio channels are frequency-division multiplexed on first, second, third, and fourth different radio frequency bands respectively.

36. The method of claim 34 wherein the first and second radio channels are time-division multiplexed on a first radio frequency band, and wherein the third and fourth radio channels are time-division multiplexed on a second radio frequency band different from the first radio frequency band.

37. The method of claim 34 further comprising receiving, at the mobile station, configuration information encoded in a configuration information signal in a configuration radio frequency band different from respective radio frequency bands of the first, second, third, and fourth radio channels.

38. The method of claim 37 wherein the configuration radio frequency band is between about 57 GHz and about 64 GHz.

39. The method of claim 34 wherein the first, second, third, and fourth radio channels have respective radio frequencies between about 57 GHz and about 64 GHz.

40. A mobile station apparatus comprising:
means for receiving a first radio signal from a first remote radio station on a first radio channel;
means for transmitting a second radio signal to the first remote radio station on a second radio channel associated with the first radio channel and different from the first radio channel;
means for receiving a third radio signal from a second remote radio station on a third radio channel different from the first and second radio channels; and
means for transmitting a fourth radio signal to the second remote radio station on a fourth radio channel associated with the third radio channel and different from the first, second, and third radio channels.

41. A mobile station apparatus comprising:
an interface for facilitating radio communication with first and second remote radio stations on first, second, third, and fourth different radio channels; and
a processor in communication with the interface and operably configured to:
receive, from the interface, a first radio signal from a first remote radio station on a first radio channel;
cause the interface to transmit a second radio signal to the first remote radio station on a second radio channel associated with the first radio channel and different from the first radio channel;
receive, from the interface, a third radio signal from a second remote radio station on a third radio channel different from the first and second radio channels; and
cause the interface to transmit a fourth radio signal to the second remote radio station on a fourth radio channel associated with the third radio channel and different from the first, second, and third radio channels.

42. The apparatus of claim 41 wherein the first, second, third, and fourth radio channels are frequency-division multiplexed on first, second, third, and fourth different radio frequency bands respectively.

43. The apparatus of claim 41 wherein the first and second radio channels are time-division multiplexed on a first radio frequency band, and wherein the third and fourth radio channels are time-division multiplexed on a second radio frequency band different from the first radio frequency band.

44. The apparatus of claim 41 wherein the processor is further operably configured to receive, from the interface, configuration information encoded in a configuration information signal in a configuration radio frequency band different from respective radio frequency bands of the first, second, third, and fourth radio channels.

45. The apparatus of claim 44 wherein the configuration radio frequency band is between about 57 GHz and about 64 GHz.

46. The apparatus of claim 41 wherein the first, second, third, and fourth radio channels have respective radio frequencies between about 57 GHz and about 64 GHz.
